(19) United States
(12) Patent Application Publication
(10) Pub. No.: US 2025/0342425 A1
(43) Pub. Date: Nov. 6, 2025

(54) AUTOMATED MULTI-PARTY DOCUMENT MANAGEMENT PLATFORM AND USER INTERACTIVE TOOL

(71) Applicant: Citizens Financial Group, Inc., Providence, RI (US)

(72) Inventors: Jessika Faulkner, East Norriton, PA (US); Pasquale Nuzzo, Stoneham, MA (US); David W. Hurt, Catonsville, MD (US); Jeffrey D. Huber, Hamburg, NY (US)

(21) Appl. No.: 19/005,365

(22) Filed: Dec. 30, 2024

Related U.S. Application Data
(60) Provisional application No. 63/643,037, filed on May 6, 2024.
(60) Provisional application No. 63/708,312, filed on Oct. 17, 2024.

(51) Int. Cl. G06Q 10/0633; G06F 21/62; G06Q 10/0635; H04L 67/306

(52) U.S. Cl. CPC G06Q 10/0633; G06F 21/6218; G06Q 10/0635; H04L 67/306

(57) ABSTRACT

Systems and methods for automating workflows, improving operating efficiency, and/or improving security in a multi-party document management platform are disclosed. The systems and methods utilize artificial intelligence (AI) models to analyze user profiles, generate risk scores for multi-party agreements, and determine risk mitigation actions. User interactions with modified agreements are monitored, and the AI models are updated based on these interactions. The system automatically adjusts operating parameters to improve operating efficiency and/or security. The methods and systems also provide for generating recommendations, utilizing user feedback, analyzing user action patterns, performing portfolio-level risk assessments, and identifying workflow inefficiencies. These features enable a dynamic, adaptive platform that continuously improves its performance in managing multi-party agreements while also enhancing security and operational efficiency.

### CROSS-REFERENCE TO RELATED APPLICATION

This application claims the benefit of priority under 35 U.S.C. § 119 (e) to prior U.S. Provisional Patent Application No. 63/643,037, filed May 6, 2024, and U.S. Provisional Patent Application No. 63/708,312, filed Oct. 17, 2024, the disclosures of which is incorporated by reference herein to its entirety.

### TECHNICAL FIELD

The present disclosure generally relates to an electronic document management platform and integrated user interaction tool that, among other things, leverages automation and artificial-intelligence (AI) to improve operating efficiencies associated with generating, processing, modifying, executing, storing, etc. multi-party electronic documents, as well as facilitating direct and live communications between and among multiple systems and/or multiple parties. To that end, the present disclosure describes a unique infrastructure that connects multiple, independent systems and datasets to enable automation between and amongst the multiple systems. In addition, the present disclosure provides unique platform features such as customizable document monitoring, automated alert generation, streamlined multi-party system integration, automated data extraction and processing, and others to further enhance the platform's overall efficiency and effectiveness.

### BACKGROUND

The increasing complexity of multi-party agreements and transactions has resulted in the use of electronic systems for document management and collaboration. Traditional document management systems, however, often lack the capability to integrate multiple systems, process large and varied datasets, and facilitate seamless communication between multiple parties. These systems typically rely on manual processes for data extraction, document generation, and task delegation, which can result in inefficiencies, errors, and delays.

Moreover, current technologies do not adequately address the challenges associated with real-time communication, multi-party collaboration, and automated workflows. Such limitations are especially evident in industries requiring significant document processing, such as legal, financial, and healthcare sectors. The inability to streamline these processes leads to high operational costs, increased turnaround times, and greater risk of human error.

There is, therefore, a pressing need for a centralized, automated, and intelligent system that enables the efficient generation, management, and processing of multi-party documents, while also facilitating seamless communication and collaboration among diverse systems and users.

### SUMMARY

The present disclosure relates to systems and methods for improving workflows, operation and efficiency in a multi-party document management platform. In various embodiments, the systems and methods leverage artificial intelligence (AI) models to analyze user profiles, generate risk scores for multi-party agreements, and determine appropriate risk mitigation actions. The systems and methods also provide for continuous monitoring of user interactions and external factors, allowing for dynamic updates to the AI models and automatic adjustments to system operating parameters.

In one aspect, a computer-implemented method is provided that includes receiving data associated with a multi-party agreement, generating user profiles, and executing AI models to generate risk scores and determine risk mitigation actions. The method further includes implementing risk mitigation actions, monitoring user interactions, updating AI models based on the monitored interactions, and automatically adjusting system operating parameters.

In another aspect, a system is provided that includes one or more processors and a memory storing instructions for performing operations similar to those of the method described above. The system is configured to manage and service multi-party agreements (and related documents), assess and mitigate risks, and continuously improve its performance through AI-driven analysis and adjustments, advanced automation, API integrations with external systems (e.g., accounting systems, payment processing systems, entitlement systems, etc.).

Both the method and system embodiments may include features such as generating and presenting recommendations for improving risk scores, utilizing user feedback to update AI models, analyzing patterns in user actions to identify potential risks and automated actions, performing portfolio-level risk assessments, and identifying and addressing inefficiencies in document processing workflows.

These and other features of the disclosed systems and methods provide for a robust, adaptive platform for managing and servicing multi-party agreements and related documents with enhanced efficiency.

### BRIEF DESCRIPTION OF DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of this disclosure and are therefore not to be considered limiting of its scope, for the disclosure may admit to other equally effective embodiments.

FIG. 1 shows an exemplary system according to the present disclosure;

FIG. 2 shows a system diagram illustrating various layers of a platform according to the present disclosure;

FIG. 3 shows an exemplary flow diagram that illustrates how a platform according to the present disclosure can connect with a back-end financial payment and accounting system to facilitate transfers of control;

FIG. 4 shows an illustrative diagram demonstrating the interoperability and connectivity within a platform according to the present disclosure, as well as from the platform to users and third-party systems and resources;

FIG. 5 shows an illustrative dashboard for display via an interactive GUI according to the present disclosure;

FIG. 6A shows an illustrative portfolio management dashboard for display via an interactive GUI according to the present disclosure; and

FIG. 6B shows an agreement-level view of the illustrative portfolio management dashboard shown in FIG. 6A, according to the present disclosure.

To facilitate understanding, identical reference numerals may have been used, where possible, to designate identical elements that are common to the figures. It is contemplated that elements disclosed in one embodiment may be beneficially utilized on other embodiments without specific recitation.

### DETAILED DESCRIPTION

The present disclosure relates to a novel centralized, multi-party document management system designed to overcome the limitations of existing technologies. The system comprises a digital platform that employs advanced automation and artificial intelligence (AI) to streamline the creation, processing, and management of multi-party electronic documents.

The system's infrastructure integrates with a variety of third-party systems, collecting disparate datasets and user inputs to intelligently and automatically generate multi-party documents. The system is also configured to employ modeling techniques to ensure accurate and efficient document creation, and it delegates tasks to designated parties based on their respective authorization levels and responsibilities.

An interactive graphical user interface (GUI) serves as the primary point of communication between the system and its users. Through this interactive GUI, users can interact with the system to review, modify, and/or approve documents, as well as engage in real-time, live communication with other parties.

Among others, several key features of the system include customizable document monitoring, allowing users to track document statuses and receive actionable alerts automatically; streamlined multi-party system integration, ensuring seamless communication and data exchange among diverse systems; automated data extraction and processing, minimizing manual input and reducing the potential for errors; enhanced task automation via a new application program interface (API) infrastructure that enables the intelligent delegation of tasks and responsibilities; and AI-powered functionalities that improve operational efficiencies by automating repetitive processes, such as document management, research, and multi-party signatures.

By leveraging automation, AI, and advanced system integrations, the system of the present disclosure addresses inefficiencies of existing electronic document management platforms, as well as errors associated with manual document processing. This centralized system enables faster turnaround times, improved accuracy, and enhanced (live) collaboration among all involved parties. The system provides a scalable and highly customizable solution that can be tailored to meet the needs of various industries.

For purposes of this disclosure, the document management system will be described in the context of deposit account control agreements (or simply, “control agreements”), which involve at least three independent party systems, namely, lender systems, debtor systems and intermediary systems. It should be understood, however, that this disclosure is not limited thereto. To the contrary, the present disclosure is applicable for any type of document management, involving any number of documents being managed, involving any number and complexity of third-party systems, and is applicable to any industry.

In some embodiments, the multi-party document management system of the present disclosure can be configured to enhance the operating efficiencies of certain types of systems and operations, particularly those systems tasked with managing large numbers (e.g., hundreds, thousands, etc.) of control agreements.

The system described herein can be configured to leverage single sign-on (SSO) technology to enable seamless access to any number of applications and services (e.g., electronic signature, payments, accounting, etc.), including those within and external to the system. In addition, the system can leverage SSO technology to facilitate digital interactions between and amongst systems, such as between third party lender systems and intermediary systems (e.g., depository institution systems) which facilitate control over their borrowers “controlled” accounts. This includes, for example, generating, signing, storing, indexing, and recalling key electronic documents, generating “cases” (e.g., an instance of an electronic document that requires correcting, approval, revisions, etc.), generating and/or circulating updates on the status of such cases, and other features such as customizable monitoring, actionable alerts and/or informational alerts. For purposes of this disclosure, actionable alerts refer to alerts that enable a user (e.g., via a live link, input screen, etc.) to initiate one or more actions directly by or through the document management platform, whereas informational alerts may provide information, documents, images, etc. to the user without enabling the user to initiate any such actions. The term ‘alert,’ as used herein, refers to one and/or both of actionable and informational alerts.

Other unique features and functions of the system described herein include (without limitation) centralized management of control agreements for lenders; new account alert features that enable lender systems to receive automated notices when debtor systems open additional account(s) that should be included in an existing agreement and/or to prompt the lender systems to initiate appropriate action; direct integration with intermediary systems (e.g., banking/financial systems) that enables automated processes for agreement termination, amendments, notices of controls, disbursement requests and more via application program interface (API) calls, which may be enabled by the digitized collection and maintenance of predetermined instructions (e.g., ultimately enabling near instant implementation times and accommodation of such in related agreement terms). In addition, the system enables users to name each agreement, add agreement notes, add placeholder agreements (e.g., for other third-party intermediary held deals), have alerts forwarded directly to each user (e.g., via e-mail, text message, etc.), receive new account alerts (if applicable), etc., as well as other industry specific widgets.

Further still, the system of the present disclosure represents a unique tool that enables lender systems to manage any number of control agreements. The interface aspects of the system are unique, and they enable any of the multi-party users to interact directly with the servicing team users (e.g., associated with the intermediary systems). This eliminates long chains of communications (e.g., whether by text message, e-mail, phone call etc.) and enables automation via digitization. As will be appreciated, such features facilitate processing/operating efficiencies.

The platform is also uniquely configured to generate, train, test, validate and deploy custom artificial intelligence (AI) models for extracting data and information from agreement documents, auto-completing agreement documents, generating supplemental agreement documents, fraud detection, auto-approving agreements (e.g., based on pre-set policies and/or rules governing types of parties (e.g., pre-approved lenders), types of agreements, etc.), etc., thereby reducing lengthy contracting/agreement times and resources, and improving overall system efficiencies.

The system also includes a digital interface that provides a centralized view of portfolios of control agreements and enables interactive features such as digital recall of documents, transmission of documents digitally, improved document processing speed and efficiency (e.g., due to back-end automations), custom document and account monitoring and reporting tailored to unique agreement terms or industry needs, and so on.

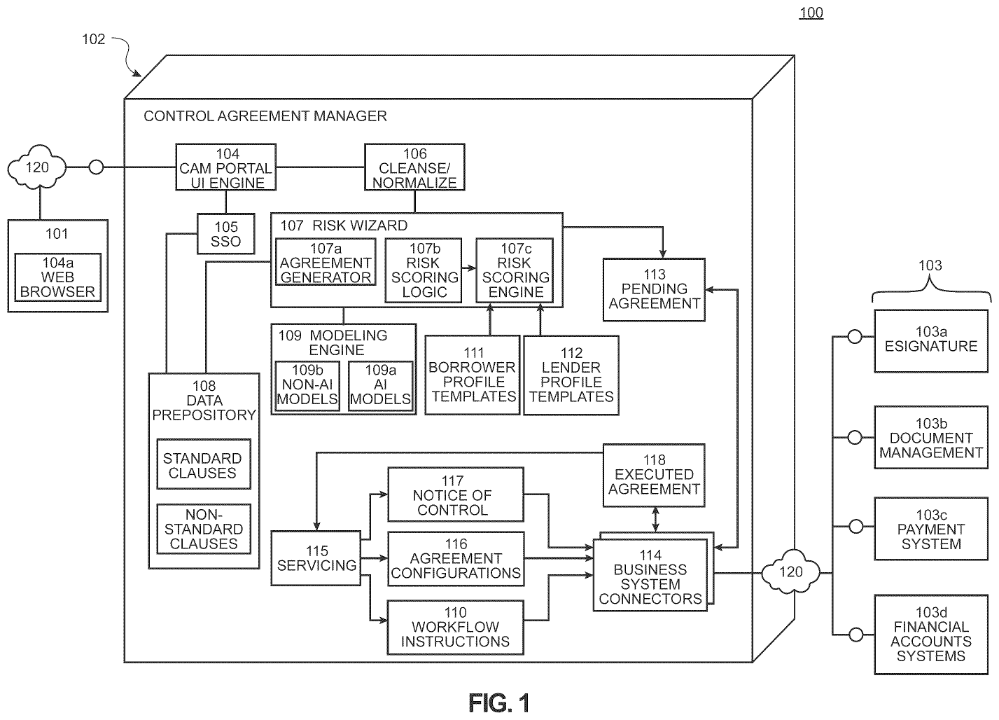

Turning now to FIG. 1, an exemplary system 100 in accordance with the present disclosure is shown. As shown, the system 100 includes one or more user devices 101, a platform 102 and one or more third party (e.g., external) systems/resources (e.g., applications, services, data sources, etc.) 103. In some embodiments, the one or more of the third-party systems/resources 103 may be cloud-based.

Each of the platform 102, the one or more user devices 101 and the one or more third-party systems/resources 103 may be operatively connected to, and interconnected across, one or more communications networks 120. Examples of communications networks 120 may include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet, Bluetooth™, low-energy Bluetooth™ (BLE), ZigBee™, ambient backscatter communication (ABC) protocols, and so on. In some embodiments, communications between or amongst the platform 102, the one or more user devices 101 and/or the one or more third-party computing systems/resources 103 may be encrypted and/or secured by establishing and maintaining one or more secure channels of communication across communications network(s) 120, such as, but not limited to, a transport layer security (TLS) channel, a secure socket layer (SSL) channel, or any other suitable secure communication channel.

The platform 102 can include one or more servers and one or more tangible, non-transitory memory devices storing executable code, software modules, applications, engines, routines, algorithms, computer program logic, etc. Each of the one or more servers may include one or more processors, which may be configured to execute portions of the stored code, software modules, applications, engines, routines, etc. to perform operations consistent with those described herein. Such operations may include, without limitation, integrating and linking the platform 102 to any number of upstream and downstream systems, user devices 101 and/or data sources, applications, services, etc. 103, monitoring and extracting data and information therefrom, executing one or more artificial intelligence (AI)/machine learning (ML) algorithms to develop user-specific product suggestions, predictions, notifications, etc., providing authentication services, and so on. For example, as described herein, the platform 102 can be configured to execute operations associated with automated multi-party document creation and processing, task delegation, real-time document updates, automated alert generation, multi-system data monitoring, and the like, all accessible via a user device 101.

The executable code, software modules, applications, engines, routines, algorithms, etc. described herein may comprise collections of code or computer-readable instructions stored on a media (e.g., memory of the platform 102) that represent a series of machine instructions (e.g., program code) that implements one or more steps, features and/or operations. Such computer-readable instructions may be the actual computer code that the processor(s) (not shown) of the platform 102 interpret to implement the instructions or, alternatively, may be a higher level of coding of the instructions that is interpreted to obtain the actual computer code. The software modules, engines, routines, algorithms, etc. may also include one or more hardware components. One or more aspects of an example module, engine, routine, algorithm, etc. may be performed by the hardware components (e.g., circuitry) itself, rather than as a result of the instructions. Although the platform 102 of FIG. 1 is shown as comprising a discrete computing system, it should be understood that platform 102 can correspond to a distributed computing system having multiple computing components (e.g., servers) that are co-located or linked and distributed across one or more computing networks, and/or those established and maintained by one or more cloud-based providers. Further, platform 102 can include one or more communications interfaces, such as one or more wireless transceivers, coupled to the one or more processors for accommodating wired or wireless internet communication across the one or more communications networks 120 with other computing systems and devices (e.g., user device(s) 101, third-party computing system(s)/resource(s) 103, etc.) operating within a computing environment.

As will be described, the platform 102 can be configured to perform any of the exemplary functions and/or processes including, among others, hosting, storing, maintaining and operating applications and services for intelligently collecting various types of data from various types of data sources, systematically processing that data, and providing efficient generation, management, and processing of multi-party documents, while also facilitating seamless communication and collaboration among diverse systems and users.

Additionally, the platform 102 can be configured to receive, generate and/or compile information and data associated with multiple users (and/or multiple user enterprises) simultaneously. Such data and information may be stored, maintained and/or accessed from a data repository 108 comprising one or more databases, for example. Examples of such data and information can include, for example, user-specific data such as a user's name, account information, login credentials, user preferences, user parameter settings, user documents, platform-developed insights, suggestions and content, user-inputs and queries, user reactions and inputs responsive to platform-generated output/suggestions, downloaded and/or uploaded data, document-specific data and information, document parameters, document templates, user tendencies (e.g., preferences as determined by the platform 102), and so on. This user-specific data can be provided and/or generated directly by the user devices 101 and/or by the platform 102 itself, as discussed below.

Data and information may also originate and/or be obtained from other sources, such as the one or more of the third-party computing systems/resources 103. Examples of such data and information may include, for example, user activity data (e.g., opening or closing of a new account at a third-party institution), user credit history data, market data, third-party documents, payment and financial accounting data, industry-specific data, and so on.

For illustrative purposes, the architecture 100 shown in this example will be described in the context of a control agreements manager (CAM) platform 102. Among other things, the CAM platform 102 (also referred to herein as simply “the platform”) in this example can be configured for governing shared control over real-world, tangible assets. To that end, the CAM platform 102 is uniquely configured to connect multiple parties (via their respective systems) and to leverage artificial intelligence (AI), including generative AI (also referred to as “gen-AI” or “GAI”), as well as non-AI modeling, to guide the users through one or more processes of establishing consensus regarding shared control of one or more designated assets. Once consensus is reached, the CAM platform 102 enables the users and/or their respective systems to monitor and act over these assets according to certain agreed-upon terms and parameters. Such acts may include, for example, automating critical functions and transfers of control over the designated asset(s). To do this, the CAM platform 102 is uniquely fully API-enabled to integrate with various back-end systems, as well as third party platforms, thereby creating a unique CAaaS (control agreement as a service) experience.

Notwithstanding the foregoing, it should be noted that the CAM platform 102 is not limited to any one configuration, use case, set of functions, industry, etc. To the contrary, the CAM platform 102 and architecture 100 described herein can be customized for implementation in any suitable industry, business, application, use case, etc. in which efficient, predictive, automated, and intelligent document creation, revision, execution, approval, management, etc. may be useful.

As shown in FIG. 1, the platform 102 includes a user-interface (UI) engine 104, a single sign-on (SSO) engine 105, a data cleansing and normalization module 106, a risk wizard engine 107, a data repository 108, an modeling engine 109, one or more libraries, services and other modules 110-113 and 115-117 (discussed below), and business system connectors 114, which itself includes a unique application program interface (API) infrastructure that includes custom integrations of APIs such as RESTful (Representational State Transfer) APIs, SOAP (Simple Object Access Protocol) APIs, and others. It should be noted, however, that the platform 102 can include any number of alternative configurations, applications, services, resources, modules, engines, etc. in accordance with this disclosure.

The UI engine 104 (also referred to as the CAM portal engine 104) can be configured to generate and dynamically update an interactive GUI 104a that may be rendered on the one or more user devices 101. As further illustrated below, the interactive GUI 104a can be configured to provide an interactive and adaptive point of access to all services, functions, resources, applications, data, etc. provided directly or indirectly by the platform 102.

The single sign-on (SSO) engine 105 can be configured to perform authentication and authorization functions, such as evaluating received log-in credentials, obtaining authorization level data associated with the received log-in credentials (e.g., from a database), and returning an authentication and authorization response.

The data cleansing and normalization module 106 can be configured to pre-process data and information, received from whatever source, for use by other modules, engines, etc. as part of the CAM platform 102. For purposes of this disclosure, pre-processing can include any combination of data cleansing operations and data normalization operations, both of which are further discussed below.

The risk wizard engine 107, in conjunction with other components of the platform 102 (e.g., the modeling engine 109 and other libraries, modules, etc. 110-113, 115-117 discussed below), can be configured to orchestrate the generation of user profiles, the generation of multi-party agreements (and supporting documents) based on the user profiles, the determination of risks associated with the multi-party agreements, the generation of recommendations to mitigate the determined risks, the transmission of generated documents to the users and/or to other services for further processing, and the management of the generated documents throughout their respective lifecycles, as further discussed below.

The data repository 108 can include any number and types of datastores, such as one or more databases, configured for storing, maintaining and/or providing access to data and information that has been obtained, generated and/or utilized by any of the user device(s) 101, the platform 102 and/or the third-party systems/resources 103. Examples of such data and information can include, for example, user-specific data such as a user's name, account information, login credentials, user preferences, user parameter settings, user queries and responses; platform-developed insights, suggestions and content; sentiment data (e.g., user responses to platform-generated output; document-related data and information such as document templates, agreement clauses (e.g., standard and non-standard), historic agreements and documents, agreement requirements, relationship data (e.g., among the parties to a multi-party agreement); risk-related data such as revenue projections, strategic values, referral sources, risk tolerance parameters, historic risk scores, historic approval/denial decisions associated with users, etc.; and so on.

The modeling engine 109 can be configured to generate, train, validate, test, execute, evaluate, re-train and re-execute one or more AI models 109a, based on current and/or historic data and information, to develop advanced analytics (including tendency analytics), predict and suggest activities based on the analytics (e.g., develop insights and recommendations to mitigate determined risks, develop suggestions in real-time based on user input, etc.), and generate and/or revise content (e.g., images, text, insights, etc.) for display via one or more user devices 101, for example.

For purposes of this disclosure, the term “AI” broadly refers to artificial intelligence and may include generative AI, machine learning (ML), and other subsets or types of AI. The term “AI model(s)” shall refer to any combination of AI algorithms, including generative AI, machine learning, statistical modeling techniques (e.g., Bayesian statistics) or any other sub-category of AI algorithms/modeling techniques. The AI models described herein can be configured (among other things) to model and analyze all forms of data and information, such as text (structured and unstructured), documents, images, videos, audio, etc., as well as modeling output generated by one or more AI models.

In the context of the CAM platform 102, the modeling engine 109 can be specifically configured to support the generation and management of multi-party agreements, the determination of risks associated with the multi-party agreements, and generation of insights and recommendations (e.g., for mitigating such risks), and the re-determination of risks and/or the re-generation of insights and recommendations responsive to changes to any of the risk-related data, document-related data, user-sentiment data, data associated with any party to the multi-party agreements, data from the third-party systems/resources 103, and so on. To do this, the modeling engine 109 can be configured to train the one or more AI models 109a with user-related data, document-related data, and risk-related data, modeling output, etc. Notably, the AI models 109a can further be trained (and re-trained) by using user-sentiment data (e.g., generated in responsive to user input and/or insights or recommendations generated by the one or more AI models 109a) to generate new training data sets, as further discussed below.

The modeling engine 109 can be operatively coupled to one or more components of the platform 102, including the risk wizard engine 107, the data repository 108, any of the libraries, services and/or other modules 110-113, 115-117, and/or any of the third-party systems/resources 103. As a result, the modeling engine 109 can be configured to receive, directly or indirectly, data and information from any number of sources, and in turn, initiate and execute one or more modeling operations described herein. As indicated above, the modeling engine 109 can also be configured to continually refine its AI models 109a based on, for example, input from a user device 101, learned tendency data, and so on (discussed below).

The type and quantity of AI models 109a that may be executed by the modeling engine 109, as well as the techniques used to train and re-train the AI models 109a, can dynamically be determined by the platform 102 according to any number of factors (e.g., model use case, instructions or data received from one or more components of the platform 102, quantity and quality of collected data, prior AI modeling results, type and source of collected data, etc.).

In some embodiments, the one or more AI models 109a can include one or more gen-AI models 109a, and the one or more gen-AI models 109a can include one or more large language models (LLMs) incorporated therein. As will be appreciated, the one or more LLMs can be configured to process or model text-based input, while other specialized models included in the gen-AI models 109a can be executed to process or model other types of data. Collectively, the gen-AI models 109a can be executed to process and model various types of input data, and in response, generate content or output having various data types. This may include, for example, generating text and image-based content (e.g., agreement clauses, risk mitigation suggestions, etc.) for display by via an interactive GUI 104a of a user device(s) 101, for example.

In some use cases, the modeling engine 109 can be configured to invoke a RAG (Retrieval-Augmented Generation) process, which comprises retrieving and providing grounding data to the LLMs from one or more external data sources 103 (e.g., credit data, pricing data, etc.). This grounding data can then be utilized by the LLMs to formulate more accurate, contextualized content and output. In some embodiments, the sources of such grounding data may be selected, preselected, and/or updated according to any number of parameters.

In some embodiments, the modeling engine 109 can be configured to process data and input provided in a natural language format (e.g., from a front-end display device), and initiate one or more responsive commands to initiate action by the modeling engine 109 and/or other components of the platform 102 (e.g., the risk wizard engine 107). To do this, the modeling engine 109 can invoke natural language processing (NLP) to interpret the input, and a converter to convert the interpreted input into the one or more commands. In some embodiments, the one or more commands can include executing one or more AI models 109a, updating one or more datasets, updating information displayed via an interactive GUI 104a. For example, in response to input provided via an interactive GUI 104a in a natural language format (e.g., a user instructional command to retrieve route-running statistics), the modeling engine 109 can leverage NLP to interpret the input and generate one or more commands to execute one or more AI models 109a and to display content generated by the AI models 109a via the interactive GUI 104a. In some embodiments, the NLP may itself comprise executing one or more LLMs discussed above, for example.

In some embodiments, the modeling engine 109 can initiate one or more actions automatically, without receiving user input, upon the occurrence of one or more predefined events and/or the existence of one or more predefined conditions as defined by the user (e.g., as input provided via a user device 101) and/or as learned or determined by the platform 102. Such events or conditions can include, for example, a change in risk-related data (e.g., a change in a party's risk-related parameters (e.g., credit score, newly opened/closed account(s), etc.), revenue projection data, and so on), a user-initiated change to a multi-party agreement, etc. To do this, the platform 102 may invoke a monitor (not shown) and/or monitoring function(s) to monitor changes to risk-related data, document-related data, user interactions with the platform 102, user interactions with unmodified and/or modified multi-party agreements, etc. The monitor function can then feed results of the monitoring to the modeling engine 109 as input, which can in turn execute one or more AI models 109a to determine if and when to initiate the automated actions. Such automated actions can include, without limitation, alert and notice generations, initiation and/or modification of one or more workflows (e.g., agreement modification, agreement termination, generation of amendment, notice of control, etc.), data extraction and/or processing, and so on. Notably, the AI models 109a executed by the modeling engine 109 may be trained and re-trained using certain threshold parameters, weights, etc. to recognize and identify the occurrence and existence of the types of events and conditions that trigger such automated actions.

In addition to gen-AI model(s) 109a, the modeling engine 109 can include, generate, train, re-train, validate, test and/or execute other types of models, such as those configured for supervised and/or unsupervised machine learning, according to the particular use case and its requirements. For purposes of this disclosure, supervised machine learning involves training AI models 109a using labeled datasets (e.g., input data that has been paired with desired output data), from which the AI models 109a can learn the mapping or relationship between the inputs and outputs and make predictions or classifications when presented with new, unseen data. For example, supervised machine learning tasks can include regression (i.e., predicting continuous values), decision trees e.g., for categorizing data into classes), neural networks, and others.

Conversely, unsupervised machine learning refers to training the AI models 109a using unlabeled datasets. As a result, unsupervised machine learning identifies patterns, structures, or relationships inherent to the data, without predefined labels or any output expectations. For example, unsupervised machine learning tasks may include clustering (e.g., k-means, hierarchical, etc.) for grouping similar data, dimensionality reduction (i.e., extracting essential features), and others.

In some use cases, the modeling engine 109 can execute a combination of supervised and unsupervised AI models. For example, as it relates to detecting anomalies (e.g., outliers) in data, the modeling engine 109 can execute one or more unsupervised machine learning models to identify the anomalies and/or gaps in data, and one or more supervised machine learning models to classify the anomalies and/or gaps. To illustrate, one or more unsupervised machine learning models 109a can be executed to identify outliers in revenue projection data, and then execute one or more supervised machine learning models to classify the data as outlier data that may be excluded from further processing. In some embodiments, the outlier data can be further classified as malicious or fraudulent. For missing data, such as gaps in any of the user-specific data, document-related data, risk-related data, etc., one or more AI models 109a can be executed to interpolate the existing data to fill in the missing gaps. Notably, the one or more unsupervised and/or supervised machine learning models 109a can be further executed to distinguish the outlier data from data that is accurate, despite being irregularly high or low. In some embodiments, users can specify policy, weight, and other parameter settings across any number of parameters which could then be used by the modeling engine 109 to identify anomalies and/or irregularities, and in response, automatically take action such as refining the data as noted above and/or adjusting one or more platform 102 operating parameters. For example, anomalies and/or irregularities deemed to be fraudulent and/or malicious, one or more platform 102 operating parameters can be adjusted to prevent further instances of such fraudulent and/or malicious data, such as modifying document approval workflows, adjusting data encryption levels for stored documents, updating authentication protocols, identifying and excluding data from sources of such data, etc. Similarly, data deemed to be duplicative or irrelevant can be excluded from future input by adjusting filter parameters, for example.

In order to train the AI models 109a described herein, the modeling engine 109 can collect historic and/or current (real-time) data and information and aggregate the same to create training data. Portions of the training data may also originate and include data from within the platform 102 (e.g., from the data repository 108, prior (or current) output generated by the AI models 109a, other applications, services or modules 110-113, 1150117) and/or from other external data sources such as the user device(s) 101 and the third-party systems/resources 103. To illustrate, a combination of user-specific data (e.g., user preferences, user parameter settings, user queries and responses, user-sentiment data, etc.), document-related data (e.g., document templates, agreement clauses (e.g., standard and non-standard), historic agreements and documents, agreement requirements, relationship data (e.g., among the parties to a multi-party agreement), etc.), risk-related data (e.g., revenue projections, strategic values, referral sources, risk tolerance parameters, historic risk scores, historic approval/denial decisions associated with users, etc.) can be collected and combined the create training data. This training data can then be utilized to train the one or more AI models 109a generate user profiles, generate multi-party agreements (and supporting documents) based on the user profiles, determine risks associated with specific to particular multi-party agreements (e.g., based on the user profiles, terms of the multi-party agreement, etc.), generate of recommendations to mitigate the specific risks of particular multi-party agreements, generate recommendations automatically (e.g., while a user is interacting with an interactive GUI 104a), transmit generated documents to the users and/or to other services for further processing, and so on.

In some embodiments, the training data can be pre-processed (e.g., by the data cleansing and normalization module 106), which may include (among other operations) removing corrupted data, augmenting the data (e.g., adding labels, annotating, etc.), resolving and/or replacing missing and/or corrupted data values (e.g., smudged image frames), filtering, formatting/re-formatting, weighting, etc., as discussed above. In some embodiments, portions of the training data may be utilized as collected, without pre-processing.

Once the training data is pre-processed (if necessary), the modeling engine 109 can utilize the training data to train respective AI models 109a for respective tasks, as noted above. Training the AI models 109a can include generating a training data set from among the training data. In some embodiments, this may include dividing the training data into multiple datasets, each dataset for use in training, validating and/or testing the respective AI models 109a. For example, a first portion of the training data may be utilized to create a training data set. This training data set can then be fed into one or more of the AI models 109a to identify patterns and relationships in the training data by solving one or more objective functions, where each objective function may comprise one or more parameters. The patterns and relationships identified during training may include, for example, user activity tendencies (e.g., spending tendencies, on-time payment tendencies), interdependencies between variables (e.g., historic risk scores and historic approval/denial decisions; AI-generated recommendations and user responses/user sentiment), user preferences, and the like.

A second portion of the training data can be utilized to create a validation data set, which may then be used to measure a performance of the respective AI models 109a according to one or more performance metrics. That is, output generated by the respective AI models 109a during training can be measured against the validation data set for accuracy (or any other performance metric). For example, terms in agreement clauses can be measured against historically-approved terms of historic agreements. If the measured performance is unsatisfactory, one or more parameters of the objective function(s) can be adjusted and the performance re-measured. This process can be iterative and continue until the performance is deemed satisfactory (e.g., meets or exceeds the one or more performance metrics).

Following training, a third portion of the training data can be utilized to create a test data set to test the respective AI models 109a. This can include, for example, applying a trained model to a simulated environment and/or data set, and measuring its effectiveness in one or more scenarios in view of the training dataset.

The trained, validated and/or tested AI models 109a can then be executed to achieve their respective and/or collective objectives. Example objectives for the AI models can include identifying outliers in collected data, determining a risk score specific to a third-party agreement, developing insights and recommendations with a high likelihood of reducing a risk score and a high likelihood of acceptance and implementation by users, etc.

In conjunction with executing one or more AI models 109a, the modeling engine 109 can also execute and apply mathematical techniques or algorithms to collected, cleansed and/or normalized data, modeling output and/or previously-determined metrics in order to derive user-specific and cumulative analytics and metrics. For example, mathematical techniques can be applied to the insights and recommendations referenced above to determine their likelihood of reducing the risk score and/or of being implemented. These detailed metrics and statistics can be combined with previously-determined metrics and statistics and further modeled to determine patterns or trends associated with the users, documents, risk scores, etc. over time. The modeling engine 109 can also apply weightings or make other adjustments to some of its calculations based on individual user profiles, combined user profiles (e.g., lender/borrower/intermediary profiles), revenue projections, historic risk scores, etc. to provide tailored, user-specific/multi-party agreement-specific insights and recommendations, for example.

Results and output of the modeling and/or mathematical operations discussed above can then be plotted, organized, summarized, etc. to create graphical representations and/or other visualizations such as tables, charts, graphs, documents, etc. for use by other components of the platform 102 and/or for presenting to users via the user device(s) 101, together with alerts, notifications, etc.

Any of the results, documents, analytics, insights, recommendations and/or other outputs generated by any component of the platform 102 can be presented to a user (e.g., parties to a multi-party agreement) via an interactive GUI 104a displayed on a user device 101, together with alerts, notifications, etc. The users can submit (e.g., via the interactive GUI 104a) input that is responsive to the results, documents, analytics, insights, recommendations and/or other output generated by the platform 102. The responsive input can include, for example, natural language text, feedback input (e.g., acceptance or denial), or other forms of sentiment or responsive input. This sentiment or responsive input can then itself be modeled (e.g., via one or more AI models 109a) and/or utilized to create one or more new training data sets. For example, in response to two recommendations for improving a risk score associated with a particular multi-party agreement, a user can provide input indicating that one recommendation is acceptable and will be implemented, and that the other recommendation is not acceptable. This input can then be utilized by the modeling engine 109 to create a new training data set that includes the original training data set, the recommendation that was deemed acceptable and/or the recommendation that was deemed unacceptable, as well as the other data and parameters used to characterize and define the multi-party agreement (e.g., profiles of the users that are party to the multi-party agreement, terms of the multi-party agreement, risk-related data, etc.). This new training data set can then be used to retrain the one or more AI models 109a configured for generating recommendations.

Any new training datasets can include a combination of current and/or historic sentiment/reactionary data, as illustrated above, and one or more of the training data sets previously utilized to train the AI models. In some embodiments, the sentiment/reactionary data can be combined with historic training data, historic sentiment/reactionary data, and/or additional current (real-time) and/or historic data to create a new corpus of training data, which may then be utilized to create the new training data sets, new validation data sets and/or new testing data sets. The new training data sets can then be utilized to re-train and/or otherwise update the AI models 109a, as discussed above in the context of generating recommendations.

The platform 102 can include any combination of libraries, services, and other modules 110-113, 115-117 for supporting operations of the risk wizard engine 107, the modeling engine 109 and other applications, services and/or operations of the platform 102. In this example, the platform 102 includes a workflow instructions service 110 for maintaining and providing a set of detailed steps outlining how each document type (e.g., multi-party agreements) should or can move through different stages of its lifecycle within the platform 102, including which user, party, service, application, system, etc. is responsible for each action, what needs to be done at each step, suggested actions, and the order in which tasks must be completed. For example, the platform 102 can offer users both boiler plate and custom options for creating their agreements, while also presenting real-time guidance to the users to help steer them towards a “standard” agreement having a high likelihood of being auto-approved with little to no exceptions. The platform 102 can also leverage its libraries, services, and other modules 110-113, 115-117 to prompt users at to take action, such as approve provisions, insert alternate provisions, route a document for additional approvals before going for signature, etc. Once an agreement is executed, the workflow instructions service 110 can inform how the executed agreement moves through its post-execution lifecycle. As will be appreciated, the libraries, services, and other modules 110-113, 115-117 help to streamline document processing and ensure proper approvals and distribution.

The platform also includes a borrower profile templates library 111 and a lender profile templates library 112. Although no shown, the platform can include additional and/or alternative types of libraries. The profile templates libraries 111, 112 in this example can be used to generate user-specific profiles for the respective users/parties to a multi-party agreement, for example. As further discussed below, the user/party profiles generated by the platform 102 can then be utilized by the risk wizard engine 107 to orchestrate generating one or more risk scores, and/or by the modeling engine 109 to generate recommendations for improving the risk scores, for example.

The platform 102 also includes a pending agreements module 113 configured to receive output from the risk wizard engine 107 and route it to one or more other modules, services, etc. of the platform 102 as informed by the workflow instructions service 110. For example, the output of the risk wizard engine 107 can include a pending, non-executed multi-party agreement. The pending, multi-party agreement can be routed, via one or more APIs, to a document library within the data repository 108, to the servicing module 115 for further servicing, and/or to any third-party systems/resources 103 for further processing (e.g., revision, approval, execution, etc.). If routed to the servicing module 115, for example, the pending multi-party agreement can be subject to one or more services such as an agreement configurations process 116, which can include revising/further configuring the pending multi-party agreement. Then, following the agreement configurations process, the pending multi-party agreement can be routed to the third-party systems/resources 103 for further processing.

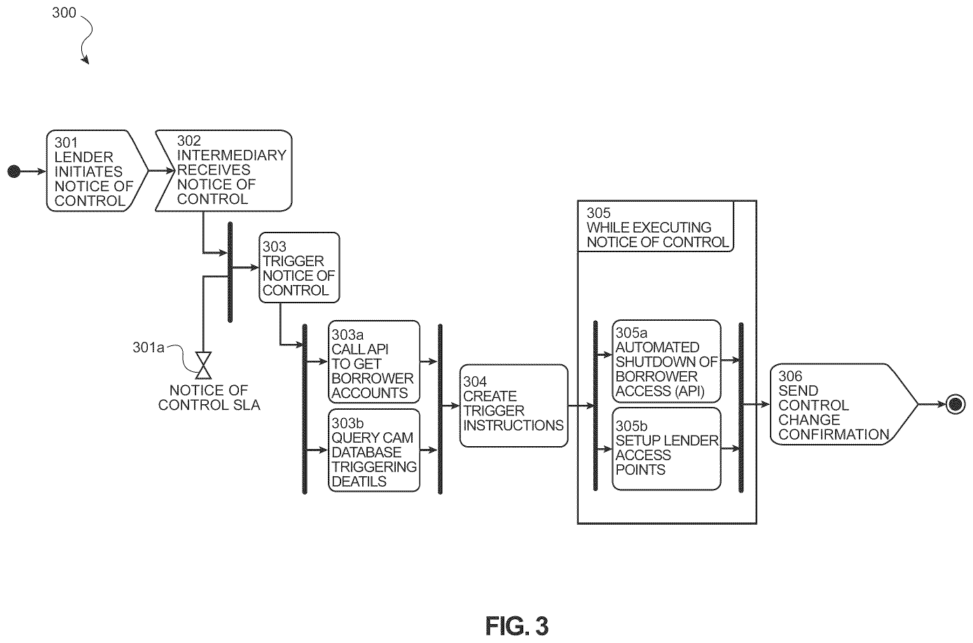

Once the pending multi-party agreement is executed (e.g., revised, approved, executed, etc.) and returned (e.g., via the business system connectors 114), the resulting executed multi-party agreement can be routed via an executed agreement module 118 to a servicing module 115 for post-execution servicing. Post-execution servicing can include, for example, initiating a notice of control process 118 (discussed below, see FIG. 3) or other services as informed by the workflow instructions service 110.

The business system connectors 114 can be configured to communicate with any number of third-party systems/resources 103, including via one or more communications networks 120. To that end, the business-system connectors 114 can include a unique API infrastructure that includes a growing library of APIs that enables the CAM platform 102 to connect to and communicate with external system components (i.e., third-party systems/resources 103). In this manner, the CAM platform 102 can operate as a plug-n-play platform that may be integrated, with limited or minimal programming/configuring, into any other third-party system and/or platform.

The API infrastructure of the business-systems connectors 114 can include several components that include, without limitation, as a standardized API library, a dynamic configuration engine, a secure authentication layer, a monitoring/error-handling framework, and components that connect to backend data sources that provide access to account data, transaction history, agreement status data, electronic signature systems, etc. In some embodiments, additional or alternative components can also be a part of the API infrastructure. The standardized API library can comprise a collection of pre-defined APIs that support various communication protocols (e.g., REST (representational state transfer), SOAP (simple object access protocol), GraphQL, JSON-RPC (JavaScript object notation-remote procedure call), WebSocket, and XML-RPC (extensible markup language-remote procedure call), and others). Each API in the API library can be equipped with detailed documentation and endpoints for case of integration to any of the third-party systems/resources 103. As mentioned above, this API library is dynamic, and can be expanded and updated.

The dynamic configuration engine enables the APIs to adapt dynamically to different third-party system/resource 103 requirements, minimizing the need for manual programming or extensive configurations. To that end, the dynamic configuration engine can be configured to support automatic schema mapping, data format translation and workflow customization.

The secure authentication layer can implement any number of authentication protocols (e.g., OAuth 2.0, SAML (security assertion markup language), etc.).

The monitoring/error handling framework can be configured to provide real-time monitoring of API usage and data transmissions between the platform 102 and the third-party systems/resources 103. In addition, this framework can include one or more error-handling mechanisms, such as automatic retries, error logging and detailed feedback for trouble shooting.

The third-party systems/resources 103 to which the platform 102 can connect to and communicate with can include any external and/or back-end systems, platforms and/or services. Examples of such external/back-end systems, platforms and/or services include, without limitation, e-signature platforms, enterprise document management systems, internal and external (e.g., third party) payment systems, financial accounting systems, customer relationship management (CRM) systems, third party financial technology (“fintech”) solutions, enterprise identify providers (IDPs), internal and/or external (third party) modeling engines and/or models (e.g., large language models), and so on.

On its front end, the one or more user devices 101 used to interact with the platform 102 can each comprise one or more tangible, non-transitory memory devices that store software instructions and/or data, and one or more processors configured to execute the software instructions. The tangible, non-transitory memory may, in some examples, store application programs, application engines or modules, and other elements of code executable by the respective one or more processors. At least one among the one or more user devices 101 can store within its respective tangible, non-transitory memory, an executable application which may be provisioned to any of the one or more user devices 101. The executable application, when executed, can provide the user device(s) 101 with access to one or more applications, services, resources, etc. of the platform 102, as further discussed below. This can include, among other things, displaying an interactive GUI 104a generated by the UI engine 104 on a display unit of the user device(s) 101, establishing communications between the user device(s) 101 and the platform 102, transmitting user data (e.g., user input) or other data and information from or to the platform 102 and/or to other systems or devices (e.g., third-party computing systems/resources 103), etc.

Each of the one or more user devices 101 can include a display unit configured to present interface elements to a corresponding user, and an input unit configured to receive input from the corresponding user (e.g., in response to the interface elements presented through the display unit). In some examples, the display unit can include, but is not limited to, an LCD display unit, a thin-film transistor (TFT) display, organic light emitting diode (OLED) display, a touch-screen display, or other type of display unit, and input unit can include, for example, a keypad, keyboard, touchscreen, fingerprint scanner, voice activated control technologies, biometric reader, camera, or another type of input unit.

In some embodiments, the functionalities of the display unit and input unit discussed above can be combined into a single device, such as a pressure-sensitive touchscreen display unit that presents interface elements and receives input from a user. In some embodiments, at least one among the one or more user devices 101 can include an embedded computing device (e.g., in communication with a smart textile or electronic fabric), or any other type of computing device that may be configured to store data and software instructions, execute software instructions to perform operations, and/or display information on an interface device or unit.

The one or more user devices 101 can also include a communications interface, such as a wireless transceiver device, coupled to one or more processors and configured to establish and maintain communications with communications network 120 via one or more communication protocols, such as WiFi®, Bluetooth®, NFC, a cellular communications protocol (e.g., LTER, CDMA®, GSM®, etc.), or any other communications protocol. In some embodiments, the one or more user devices 101 can also establish communications with one or more additional computing systems (e.g., third-party computing systems/resources 103) or devices (e.g., others among the one or more user devices 101) operating within the system 100 across a wired or wireless communications channel, such as communications network 120 (e.g., via a communications interface using any appropriate communications protocol).

Examples of the one or more user devices 101 can include, but are not limited to, any combination of mobile phones, smart phones, tablet computers, laptop computers, desktop computers, server computers, personal digital assistants, portable navigation devices, mobile phones, smart phones, wearable computing devices (e.g., smart watches, wearable activity monitors, wearable smart jewelry, glasses and other optical devices that include optical head-mounted displays (OHMDs)), embedded computing devices (e.g., in communication with a smart textile or electronic fabric), or any other computing device configured to capture, receive, store and/or disseminate any suitable data.

In an exemplary embodiment, a user such as lender, borrower, and/or intermediary (e.g., relationship manager or other service team user associated with an intermediary system, etc.) can connect to the CAM platform 102 via a web browser displayed on a display unit of a respective user device 101.

Upon accessing the web browser, the user may be prompted (e.g., via a prompt message displayed within the web browser on the display unit of the user device 101) to enter log-in credentials. In some embodiments, the user's log-in credentials can be automatically pre-populated (e.g., from the user device's 101 memory) in a designated log-in area within the web browser in response to the log-in prompt.

Alternatively, the user may connect to the platform 102 via a software application that resides directly on the user device 101, as discussed above. In some embodiments, the software application can be accessed through a cloud service provider, for example. Once the software application is launched, the user can be prompted for log-in credentials. In some embodiments, the log-in credentials can be pre-populated (e.g., from the user device's 101 memory) in a designated log-in area within the display unit and generated by the software application in response to the log-in prompt.

Once the user's log-in credentials have been entered into the designated log-in area and submitted, the user's log-in credentials can be transmitted, via a communications interface over a communications network 120, to the platform 102 for processing by the SSO engine 105. In some embodiments, the user's log-in credentials can include one or more of a username and password, biometric data, voice data, and/or any other authentication information.

Upon receiving the log-in credentials, the SSO engine 105 can perform authentication and authorization functions, such as evaluating the received log-in credentials based on log-in credentials stored in a database (e.g., within data repository 108), obtaining authorization level data associated with the received log-in credentials (e.g., from the database), and returning an authentication and authorization response. If the log-in credentials are authenticated, access to the platform 102 can be granted in accordance with the user's authorization level. Alternatively, if the log-in credentials are not authenticated, the SSO engine 105 can return an access-denial response and/or a prompt to re-enter the log-in credentials. In some embodiments, various features, and functions available through the platform 102 can be determined by a combination of the user's authorization level and the tasks delegated to the user by the platform 102.

Once the user is authenticated and has successfully logged-in to the platform 102, the user may be granted access to various applications, services, resources, etc. to which the user is authorized to access. In some embodiments, the user can be presented with an interactive GUI 104a generated by the CAM platform's 102 UI engine 104. The interactive GUI 104a can include selectable icons, data input areas, and/or one or more display areas for displaying graphics, statistics, video clips, etc.

The user can provide, via the interactive GUI 104a, data and information associated with the user and/or the user's enterprise. In this regard, the interactive GUI 104a can be configured for requesting, receiving, extracting, uploading, scanning, and/or otherwise collecting data and information from the user. The data and information may take any form, including (without limitation) text (structured and unstructured), image data, documents, voice data, video data, biometric data (e.g., facial recognition, eye scan, fingerprint, etc.), and so on, in any data format.

In some embodiments, data and information can also be collected from other sources, such as from third party data systems and resources 103. The data and information collecting can occur automatically, such as according to a schedule, upon the occurrence of predetermined events, etc. and/or ad-hoc by the user of the platform 102. In some embodiments, the CAM platform 102 can be configured to retrieve data and information from the third-party systems/resources 103 (e.g., via web scraping and mining, downloading from cloud services, etc.), and in some embodiments, the third-party systems/resources 103 can push data and information to the CAM platform 102 (e.g., via live data feeds, etc.).

In some embodiments, the CAM platform 102 can also access and utilize previously generated, collected and/or stored data and information, such as from memory and/or from one or more databases that are a part of and/or are accessible by the CAM platform 102 (e.g., data repository 108).

Once collected, the data and information can be pre-processed by the data cleansing and normalization module 106, if necessary. As noted above, the data cleansing and normalization module 106 can be configured to pre-process data and information, received from whatever source, for use by other modules, applications, services, engines, etc. of the platform 102. For purposes of this disclosure, pre-processing can include any combination of data cleansing operations and data normalization operations. Data cleansing operations can include, for example, error detection and correction, which can include detecting anomalies such as missing data values, extreme outliers and/or duplicate data entries. Upon detecting such errors, interpolation and/or extrapolation routines can be initiated to fill-in gaps, replace erroneous (outlier) data and/or remove duplicate data or other noise.

Normalization, on the other hand, can involve standardizing data units and data formats to ensure consistency across different types of data. Normalizing can also involve scaling and/or dimension reduction, to prepare the data for storage and/or analysis.

In some embodiments, data and information can be pre-processed by the data cleansing and normalization module 106 before being stored in a structure format by the data repository 108. For example, received data may be cleansed, then organized and stored in the data repository 108, before being retrieved and normalized for use by other components of the platform 102 (e.g., risk wizard engine 107, modeling engine 109, etc.). In other embodiments, the organizing, cleansing, storing and normalizing operations can occur in other sequences.

In some embodiments, one or more of the pre-processing operations discussed above can include executing one or more AI models 109a to identify and remove corrupted data, augment received data (e.g., adding labels, annotating, etc.), resolve and/or replace missing and/or corrupted data values (e.g., missing/outlier pricing data), filter, format, re-format, weight and/or otherwise transform the data to make suitable for storage, retrieval, modeling and/or further processing. In some embodiments, portions of the data and information can be utilized as received or collected, without pre-processing. As will be appreciated, cleansing and normalizing the data and information into complete data sets having standardized form(s) and/or format(s) facilitates transformation and use of the data and information by other components of the platform 102 to generate, for example, risk scores, multi-party documents, risk-mitigation recommendations, etc.

Once cleansed and normalized (if necessary), data and information can be utilized by the risk wizard engine 107 to orchestrate the generation of user profiles, the generation of multi-party agreements (and supporting documents) based on the user profiles, the determination of risks and risk scores associated with the multi-party agreements, the generation of recommendations to mitigate the determined risks, the transmission of generated documents to the users and/or to other application, systems, services, etc. for further processing, and the management of the generated documents throughout their respective lifecycles. As shown, the risk wizard engine 107 includes an agreement generator 107a, risk scoring logic 107b and a risk scoring engine 107c. In other embodiments, the risk wizard engine 107 may include one or more additional or alternative modules, each for performing one or more functions described herein.

In operation, the risk wizard engine 107 can access one or more profile templates from one or more of its profile template libraries 111, 112 to generate user-specific profiles for respective users associated with a multi-party agreement. For example, the risk wizard engine 107 can access a lender profile template from the lender profile templates library 112 to generate a lender profile based on lender-specific data and information. This data and information can be received via a lender user device 101 and/or, if previously received and stored, from the data repository 108. In some embodiments, the lender-specific data and information may include, for example, conditions and clause requirements for a multi-party agreement, authorized parties to service the agreement, account information, notice of control event rules, lender documents (e.g., evidence, preferences, etc.), notice of control requirements, etc.

Similarly, the risk wizard engine 107 can create a borrower profile using a borrower profile template from the borrower profile templates library 111. In some embodiments, borrower-specific data and information used to create the borrower profile may include, for example, the borrower's name, identification number, cash activities, current accounts, account balances, volumes, treasury service products, documents of incorporation, borrower evidence documents, etc. As with the lender-specific data and information, the borrower-specific data and information can be obtained from a borrower user device 101 and/or, if previously received and stored, from the data repository 108.

Next, the risk wizard engine 107 can cause its risk scoring engine 107c to initiate a scoring process to generate a risk score for each of a lender-party and a borrower-party according to the lender profile and borrower profile, respectively. To do this, the risk scoring engine 107c can access and utilize stored risk scoring logic 107b. In some embodiments, the risk scoring logic 107b can include executing one or more AI models to evaluate/model a combination of parameters. Each having a corresponding and configurable weighting, to determine a risk score. Examples of the types of parameters that can be modeled to generate the risk score can include, without limitation, lender profile data, borrower profile data, revenue opportunities, deposit amounts, cross-sell opportunities, strategic value, referral source, number of accounts, agreement requirements, legal exposure score, known operational and servicing risks, notice of control requirements, etc.

Once the risk scores for each of the lender-party and borrower-party are generated, the lender-profile, the borrower profile and their respective risk scores, together with other data and information collected by the CAM platform 102, may then be fed to the risk wizard engine's 107 agreement generator for use in creating a multi-party agreement. Such other data and information may include, for example, revenue projections, strategic value, referral sources, risk tolerance, agreement requirements, and other information associated with an intermediary-party that will constitute a third party to the multi-party agreement, existing relationship information (e.g., between any of the lender-party, borrower-party and intermediary-party), past control agreements involving one or more of the lender-party and borrower-party, past risk scores and/or decisions associated with any of the lender-party and/or borrower-party, information previously generated and/or captured by the CAM platform 102 relating to any of the lender-party and borrower-party, external data and information from any of the third-party systems/resources 103, such as industry trend data, emerging terms and conditions, existing account information of other accounts associated with any of the lender-party and/or borrower-party, market data, interest rates, etc.

With the foregoing data and information, the risk wizard engine's 107 agreement generator 107a can send instructions to the modeling engine 109 to execute one or more AI models 109a and/or one or more non-AI models 109b from its modeling library(ies) to identify and procure agreement clauses from the data repository 108. That is, the one or more AI models 109a and/or non-AI models 109b can utilize as input the profiles and risk scores generated by the risk wizard engine 107, together with the other data and information collected by the CAM platform 102 and referenced above, to identify agreement clauses (from the data repository 108) that comply with the requirements, conditions, and other parameters set forth by the lender-party, intermediary-party and borrower-party. In some embodiments, the one or more AI models 109a and/or non-AI models 109b can be configured to select clauses that have a highest likelihood of being accepted and/or exercised (e.g., as determined by one or more other AI models 109a). In some embodiments, the multi-party agreement can include both standard and non-standard clauses. The agreement generator 107a can then formulate a draft of the multi-party agreement that includes the identified agreement clauses for review, edit, approval, and/or signature by the parties. In addition, the agreement generator 107a can generate other documents and information (e.g., agreement summary, risk scores, revenue forecasts, etc.) that support and accompany the draft multi-party agreement.

In addition to identifying and procuring agreement clauses, one or more AI models 109a can be executed to identify and generate one or more risk score mitigation/improvement options. That is, based on the risk scores of the parties and/or other parameters, one or more of the AI models 109a can be executed to identify one or more recommended actions (e.g., addition of conditions/requirements, adjustments to loan amount, etc.) to mitigate risks and/or improve party risk score(s) associated with the multi-party agreement. In some embodiments the one or more recommended actions can include, for example, modifying or adjusting one or more of the conditions, terms, parameters, requirements, etc. used to generate the multi-party agreement, closing, or consolidating one or more accounts (e.g., borrower-party accounts), and others.

The draft multi-party agreement, the risk score mitigation options, and the other documents and information generated by (or received by) the agreement generator 107a can then be aggregated, bundled with instructions, and transmitted, via the business system connectors 114, to one or more of the third-party systems/resources 103 for further processing. For illustrative purposes, the third-party systems/resources 103 shown in FIG. 1 include an eSignature application 103a, a document management application 103b, a payment system service 103c and a financial-accounts systems service 103d, each of which can be cloud-based and/or hosted on a separate platform. As noted above, however, the third-party systems/resources 103 can include any number of external systems, platforms, data sources, etc., such as customer relationship management (CRM) systems, third party financial technology (“fintech”) solutions, enterprise identity providers (IDPs), internal and/or external (third party) modeling engines and/or models (e.g., large language models), market-data feeds, and so on.

The eSignature application 103a, upon receiving the document bundle, can be configured to process the bundle to enable distribution and digital signing of the draft multi-party agreement, as well as any amendments, addendums, notices of control, or other documents associated with the multi-party agreement that requires a signature, in a manner that ensures the integrity and legality of the electronic signatures.

The document management application 103b can be configured to store and organize the transmitted bundle, enabling secure access, edits, and version control of the draft multi-party agreement, and provide compliant retention of the same. In this manner, the document management application 103b can facilitate collaboration and document sharing among parties.

The payment system service 103c can be configured to facilitate any financial transactions associated with the multi-party agreement. This can include, for example, processing payment-related clauses outlined in the multi-party agreement, including transaction scheduling, invoicing, and financial tracking. This service can also provide payment verification and reconciliation services, as well as the governing of movement of money through various channels (e.g., wire transfers, checking accounts, online banking, ACH payments, mobile payment, etc.).

The financial-accounts systems service 103d can provide integration with financial institutions to manage account-related operations, such as fund disbursements, collateral adjustments, account reconciliations, real-time financial analytics, and report, and/or others.

Each of the third-party systems/resources discussed above can be configured to communicate their respective processing results and status updates back to the platform 102 via one or more APIs. The platform 102 can then integrate this feedback for further actions or revisions, as needed.

As noted above, the platform 102 is also configured to generate an interactive graphical user interface (GUI) for display on one or more user devices 101. In some embodiments, the platform 102 can be configured to generate an agreements management dashboard for display via an interactive GUI 104a. This dashboard can be configured to provide users with an organized and efficient way to view, access and manage their respective agreements. One of the dashboard's key features includes an ability to organize agreements into portfolios that users can view, access, and manage collectively. These portfolios can be displayed in various formats such as lists or tables, where each agreement can be represented by an actionable link or icon that, when selected, opens an agreement details window or page.

The dashboard can also offer options for filtering and sorting agreements according to various criteria (e.g., agreement status or type, date created, etc.), thereby enabling users to customize their respective views to focus on specific data points (e.g., agreement type, activity date, deadline, etc.). In some embodiments, the dashboard can be configured to filter and/or sort agreements across portfolios. In addition, agreement data can be exported from the dashboard to spreadsheet formats for offline analysis, and users can download copies of agreement-related documents for archiving or sharing.

Upon selecting the links/icons to navigate to agreement details, users are provided with a detailed view of all associated documents and data, allowing users to review or edit agreement data and information directly within the dashboard. This feature of the interactive GUI 104a can be configured to reflect real-time changes in agreement and account level data, ensuring that users have access to the most current information and can respond promptly to new developments. Agreement-level detailed information such as party names, agreement status, duration in the status, last activity date, and the like can be displayed alongside each agreement, and users can customize which data fields are shown to match their specific workflow requirements. Users can also interact with the agreement-level data and information, which includes initiating one or more actions directly from within the agreement-level view of the dashboard. For example, users can request agreement terminations, generate amendments, authorize disbursements, or other agreement-related activities, streamlining implementation of these actions and any related document generation, execution, and storage.

Data from integrated third-party systems/resources 103, such as payment processing or document management platforms, can also be accessible directly through the dashboard, creating a seamless user experience for managing all aspects of agreement lifecycle activities. As will be appreciated, the foregoing features enhance both the usability and relevance of the dashboard and of the overall platform 102 itself. Further, the dashboard can also be configured to automatically generate alerts and email notifications for key updates and/or actions, such as agreement deadlines, account balance thresholds or transaction alerts, keeping users informed without manual tracking.

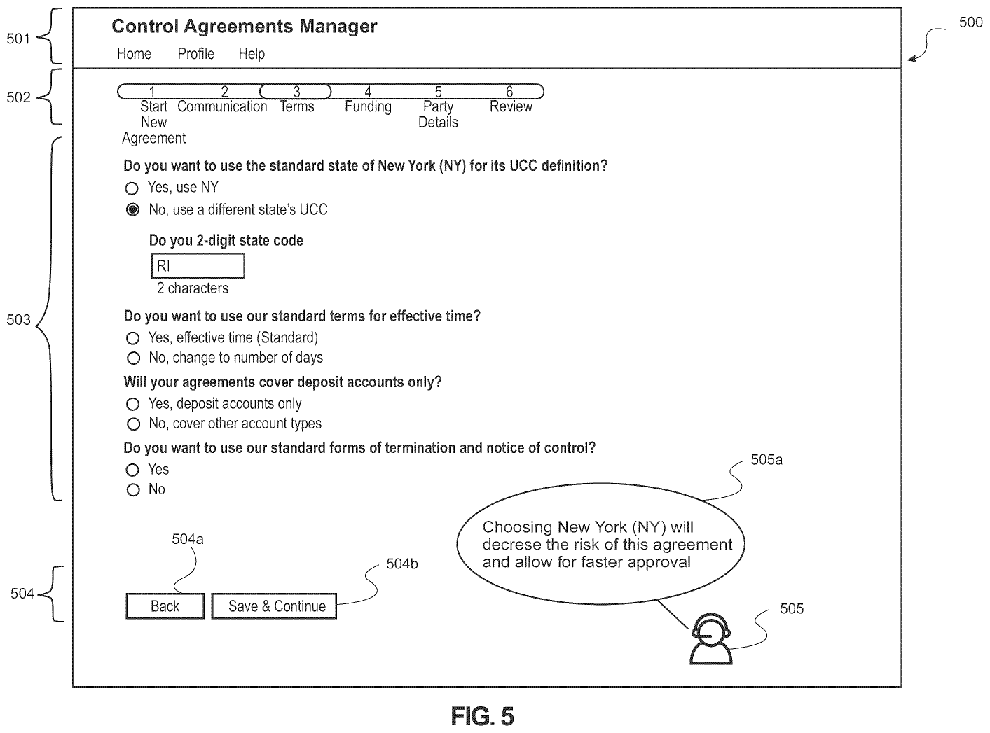

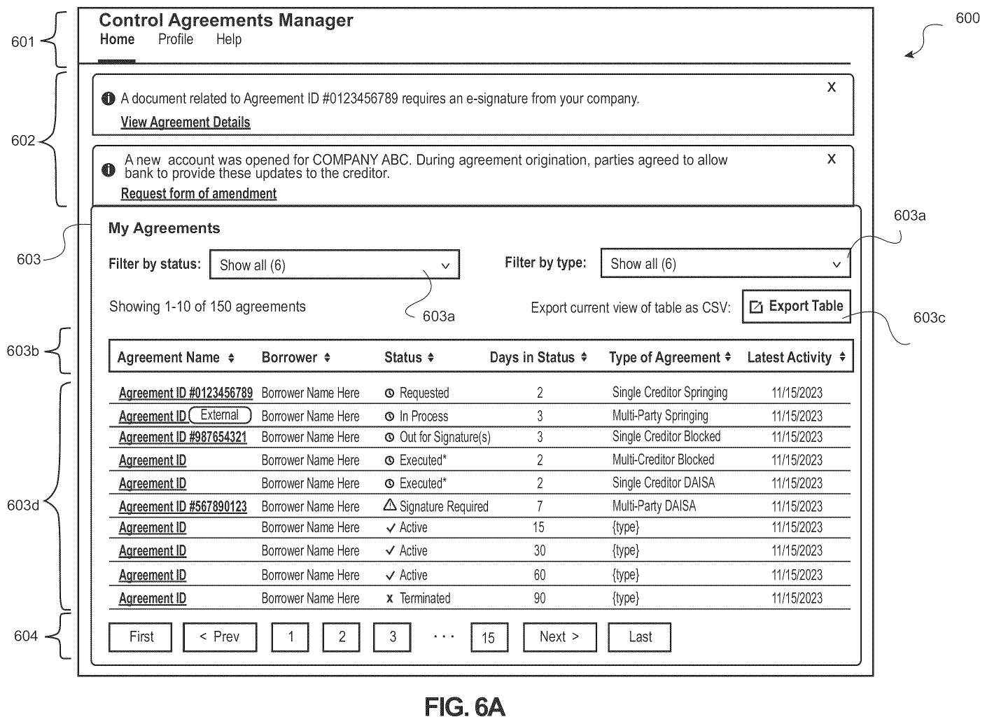

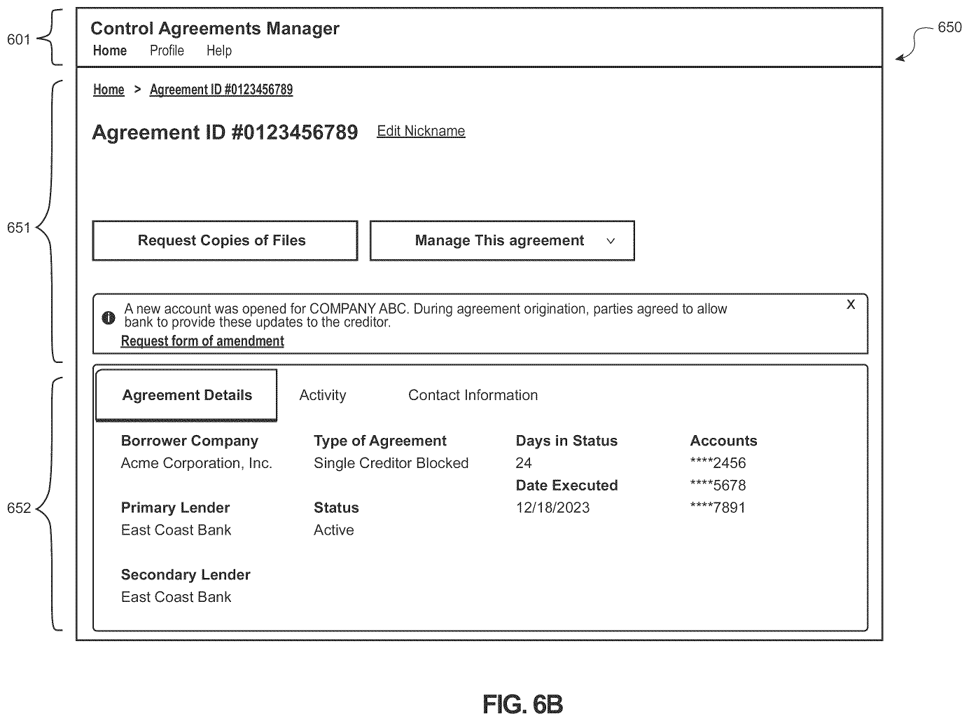

The integration of the interactive GUI 104a with the platform's operations ensures that users have a centralized and interactive hub for managing agreements. As noted above, the dashboard dynamically and automatically updates to reflect real-time changes in agreement, account, and servicing request data, such as status or deadlines, providing users with accurate and up-to-date information. It enhances collaboration through actionable links, notifications, and streamlined workflows, enabling stakeholders to communicate and resolve issues efficiently. By interfacing seamlessly with the platform's API infrastructure, the interactive GUI 104a allows data from third-party systems/resources to be displayed and managed directly within the dashboard, further simplifying agreement lifecycle management, and improving user productivity. Illustrative dashboards for display via an interactive GUI are further discussed below in connection with FIGS. 5, 6A and 6B, each of which depicts an exemplary dashboard screen.

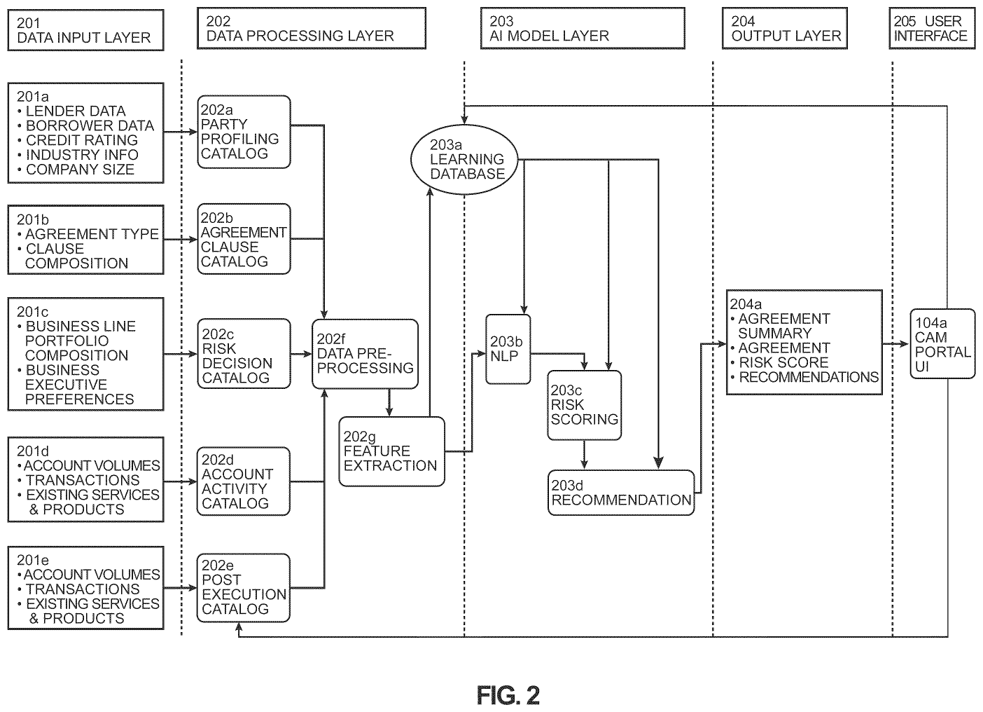

Turning now to FIG. 2, an exemplary system diagram illustrating various layers of a CAM platform according to the present disclosure is shown. The layers depicted in FIG. 2 will be discussed with reference to the system exemplary system 100 discussed above and depicted in FIG. 1. As noted above, data and information collected by the CAM platform 102 can be combined and used as input to one or more models (e.g., gen-AI models 109a in FIG. 1) to provide users with predictive and generative agreement suggestions and insights. In addition, components of the CAM platform 102, such as the risk wizard engine 107 (e.g., see FIG. 1), can be configured to leverage feedback and/or input from users and other data sources, such as agreement preferences, user-selected parameters, company context, historical approval/denial decisions, external market data, pre-determined risk thresholds, etc., to generate/predict market trends and alerts at an agreement level (e.g., pertaining to a particular agreement and/or any of its associated amendments, addendums, notices of control, and/or other related documents) and/or at a portfolio level (e.g., pertaining to a group or portfolio of selected agreements and their respective associated amendments, addendums, notices of control, and/or other related documents), provide risk-adjusted agreement suggestions during origination, enable self-directed, smart alerts for ongoing agreement management, and more.

To illustrate, an exemplary smart alert can advise a user that there has not been any activity for greater than one year in connection with a particular agreement. Another example smart alert/suggestion can recommend that a user review certain information to ensure it is remains accurate, while also providing an actionable link that guides the user through a review of the information in question. A third example of a smart alert/suggestion could inform the user that as of a certain date, a percentage of the user's portfolio included a notice of control, and of the agreements within the portfolio that are subject to a notice of control, a certain percentage of them are in a particular industry. This third example smart alert could further suggest to that the user consider approaching future arrangements with that particular industry with caution. In a fourth example, one or more suggested or user-defined updates (e.g., user's mailing address, last name, etc.) can be applied in batch to multiple agreements within or across one or more portfolios.

As shown in FIG. 2, the exemplary CAM platform 102 can comprise a data input layer 201, a data processing layer 202, a modeling layer 203, an output layer 204 and a user interface (UI) layer 205. Notably, other embodiments may include alternative combinations of layers, and each such layer may be configured according to the particular implementation.

At the data input layer 201, user-specific data 201a (e.g., lender-party data, borrower-party data, user credit rating, borrower industry information, borrower company size, etc.), agreement-related data 201b (e.g., agreement type, clause composition, etc.), business line information 201c (e.g., relating to the intermediary-party, such as portfolio composition, executive preferences, etc.), user account-related data 201d (e.g., lender/borrower account volumes, transactions, existing services and products, etc.), and other types of data and information 201e (e.g., timing and likelihood of exercising agreement clauses, past clause types exercised, etc.) can be collected or retrieved from user devices 101, from the platform 102, from external third party systems/resources 103 such as cloud storage, existing CRM systems, account data sources (e.g., from backend data lakes, mainframe servers, etc.), and other sources of historical data involving the parties, users, transaction types, etc.

At the data processing layer 202, the collected data and information can also be pre-processed 202f, for example, via a data cleansing and normalization module 106 included in the data processing layer 202. As discussed above, pre-processing 202f can include (among others) removing noise (e.g., duplicates, corrupted data, etc.), resolving missing data values, filtering, normalizing, scaling, and augmenting the data (e.g., to add labels and additional data types), and the like. In some embodiments, pre-processing 202f can also include categorizing and cataloguing the data and information for ease of storage, retrieval, and/or further processing. In this example, the user-specific data 201a can be catalogued in a Party Profiling Catalog 202a, the agreement-related data 201b in an Agreement Clause Catalogue 202b, the business line information 201c in a Risk Decision Catalog 202c, the user account-related data 201d in an Account Activity Catalog 202d, and the other types of data and information 201e in a Post Execution Catalog 202e. As will be appreciated, the collected data and information can be catalogued differently, according to the needs of the particular embodiment.

As a result of pre-processing 202f, the data and information may be converted into a format that other layers of the CAM platform 102 (e.g., the modeling layer 203) can understand and utilize effectively. The data processing layer 202 can also perform feature extraction 202g from the collected data and information to develop more informative and useful datasets for use by the modeling layer 203, for example.

In the modeling layer 203, one or more AI models 109a and non-AI models 109b can be executed, for example, using data and information from the learning database 203a as input, to generate user profiles (e.g., lender profiles, borrower profiles, etc.), determine risk scores 203c, identify agreement clauses, generate risk mitigation suggestions 203d, and so on. These operations can be performed, for example, by a combination of the risk wizard engine 107, the modeling engine 109 and the data repository 108 discussed above. In addition, the AI models 109a can be configured to identify true drivers that impact risk scores, approvals, rejections, etc., and utilize this information for generating improved risk mitigation options. Input to such AI models 109a can include, for example, user-specific data and risk-related data.

In some embodiments, the AI models 109a can also be configured for continual learning and updating from prior modeling output and/or from user and system feedback, as noted above. For example, the AI models 109a, based on the acceptance (and/or rejection) of clauses or language in its draft multi-party agreements, risk scores, risk mitigation options and recommendations, and/or other output 204a generated by the output layer 204, can receive feedback (e.g., via a CAM portal user interface 205a generated in the user interface layer 205). This feedback can take any form, such as structured text, natural language input, etc., and can be used as input to the AI models 109a to identify tendencies (e.g., acceptance rate), user sentiment, etc. associated with certain profile parameters, conditions, requirements, risk scores, agreement clauses, etc. To do this, the feedback can be processed and/or pre-processed, fed back into the modeling layer's 203 learning data base 203a and/or to one or more catalogues 202a-202e in the data processing layer 202. The feedback can then be natural-language processed 203b, if necessary, and used to create a new training data set to re-train and/or update one or more AI models 109a. This new training data set could comprise a combination of an initial training data set and the feed back. The now-updated AI models 109a could then be executed to construct future agreements, future risk mitigation options, etc. in a manner that intelligently accounts for the feedback. The acceptance and/or rejection of the future agreements, future risk mitigation options and other future output can similarly be fed back into the learning database 203a and/or catalogues 202a-202e, and again used to further refine and improve the modeling output. In this manner, a continuous feed-back loop can be utilized so as to continually improve the AI models 109a and their respective modeling output.

Turning now to FIG. 3, an exemplary flow diagram showing how the CAM platform 102 of the present disclosure may connect with a back-end financial payment and accounting system to facilitate a notice of control process 300, as referenced above in connection with FIG. 1. The notice of control process 300 can be initiated, for example, to perfect and inform users and other parties of a change in control of one or more financial accounts associated with a multi-party agreement. As further discussed below, the CAM platform 102 can be configured to enable the fast delivery of instructions pertaining to a multi-party agreement, and the platform's API infrastructure, in turn, can facilitate the fast implementation of those instructions, thereby increasing the usefulness of the entirety of the multi-party agreement.

As shown in the exemplary flow diagram of FIG. 3, the notice of control process 300 can commence when a user (e.g., a lender-party to the multi-party agreement) at Step 301 initiates a notice of control 301a by submitting the notice to the CAM platform 102, for example, via an interactive GUI 104a displayed on the user's user device 101. At Step 302, the CAM platform 102 can transmit the notice, either directly or via a third-party service or resource 103, to another party to the multi-party agreement, such as the intermediary. Digital delivery of the notice Step 302 can in turn trigger a notice of control event to be executed by the CAM platform 102 at Step 303. This notice of control routine 303 can involve a call to an API 303a to obtain account information of a borrow that is party to the multi-party agreement 303a, as well as a query 303b to a CAM platform database 108 for notice of control preferences and agreement details. The CAM platform 102 can retain current agreement settings generated from the (original) multi-party agreement, as well as subsequent amendments thereto, so as to maintain a complete history of the multi-party agreement.

In response to the API call, the CAM platform 102, at Step 304, quickly retrieves and combines current systems and service data (e.g., user account data, including how to access the user's accounts) with stored agreement settings data to generate a custom digital instruction package for executing the notice of control process 300. At Step 305, the CAM platform 102 can deliver the custom digital instruction package to the back-end financial payment and accounting system for execution. As noted above, the stored agreement settings pertain to the original multi-party agreement and to any subsequent amendments thereto. As a result, the custom digital instruction package generated (at Step 304) therefrom will also comply with the original multi-party agreement and its amendments. Meanwhile, while executing the notice of control (Step 305), the CAM platform 102 can automatically shut down the borrower's access to the multi-party agreement 305a, while also setting up lender access points according to the notice of control instructions 305b. Once the notice of control has been completed (at Step 305), the CAM platform 102 can send a notice of control confirmation to the parties involved at Step 306.

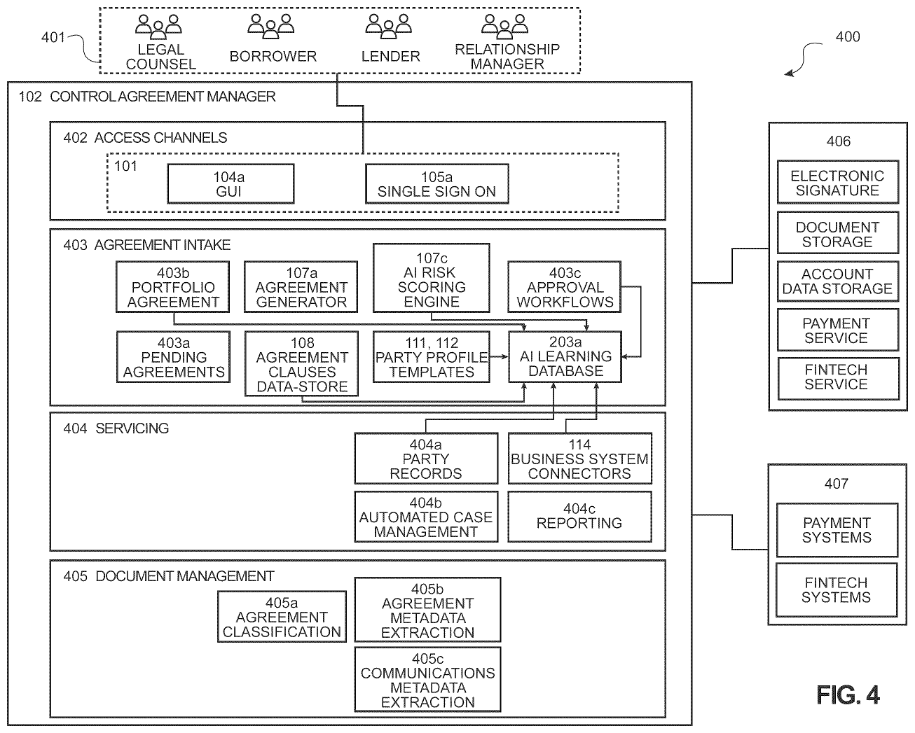

Turning now to FIG. 4, an illustrative diagram 400 demonstrating the interoperability and connectivity within the CAM platform 102, as well as from the CAM platform 102 to users and third-party systems/resources 103 is shown. Through this interoperability and connectivity, facilitated by the platform's API library (e.g., included in the business system connectors 114 of FIG. 1, discussed above), the CAM platform 102 can provide a unique CAaaS (control agreement as a service) experience, including by integrating with various back-end third party systems/resources 103. As a result, users can view, through the CAM platform 102, agreement level and portfolio level data, including a status of in-process agreements, view and manage smart monitoring alerts, initiate new requests to various parties and view the status of such requests, refer and complete relevant digital know-your-customer (KYC) processes, view and interact with historical transaction data across accounts implicated and/or included within the scope of one or more agreements, recall executed agreements, amendments and other related documents and data related thereto from sources such as an enterprise document repository, for example, and the like.

In this illustrative diagram 400, the CAM platform 102 modules, engines, services, applications, components, etc., as well as external systems 103 and devices 101 (e.g., collectively, components of system 100) are grouped into several operational/functional categories, and arranged with directional arrows drawing between components to illustrate how the different components interact to enable the features and functions described throughout this disclosure. The operational/functional categories include users 401, CAM Channels 402, Agreement Intake 403, Servicing 404, and Document Management 405. Users 401 can include parties to one or more agreements and/or any other parties authorized to access or leverage the CAM platform 102, for example, to manage portfolios of agreements, counsel users and/or provide feedback to the platform 102, and the like.

As shown in this FIG. 4, the users 401 can include lenders, borrowers, legal counsel, relationship managers (e.g., associated with an intermediary) and any other party referenced herein. Users 401 can access and interact with the CAM platform 102 via any number of CAM Channels 402, which can include user devices 101 equipped with any number of services (e.g., phone, email, etc.) and a display for displaying an interactive GUI 104a generated by the platform's CAM portal UI engine 104). Through an interactive GUI 104a, users 401 be authenticated and authorized via the platform's SSO service 105a (e.g., provided by the platform's SSO engine 105). Once authenticated and authorized, the users 401 can access any number of third party resources/services 406 and systems 407, which can include applications, services, modules, applications, etc. within the platform 102 and/or from third-party systems/resources 103, such as electronic signature services, document storage, account data storage, payment service, fintech service, and others. Such access is made possible via the API library that is a part of the business systems connectors 114 included in the Servicing category 404.

The Agreement Intake 403 category can include components for managing agreements and portfolios of agreements on an account level. Within the Agreement Intake 403 category, platform components such as the risk wizard engine's agreement generator 107a and risk scoring engine 107c can utilize agreement clauses from the data repository 108 and party profile templates from libraries 111, 112 to generate multi-party agreements that follow an approval workflow 403c to become approved agreements, as discussed above. While completing the approval workflow 403c, each agreement can be considered a pending agreement 403a, while approved and completed agreements can be included in a portfolio of agreements 403b, such as a lender portfolio 403b, for example. Each of the components in this Agreement Intake 403 category can feed a learning database 203a which, as discussed above, can receive input to continue to update and improve its output.

Other components, such as the party records 404a (which can include lender-party data, borrower-party data, intermediary-party data, etc.) and business system connectors 114 of the Servicing 404 category can also feed the learning database 203a. The Servicing 404 category can include components for servicing pending agreements 403a and portfolios of agreements 403b (which can include executed/in-force agreements). This category of components 404 can include automated case management services 404b, reporting services 404c and other services and operations that are not shown in this figure. Automated case management 404b can include detecting (e.g., via the platform's monitoring functions) an event that requires action (e.g., a change in status of an agreement or related document, a notice of control process is initiated, a backend account changes, and the like), and in response, automatically creating a “case” (e.g., an action ticket) for that event. The created case can include details of the event, the associated agreement and accounts, and the information and action(s) need to process and resolve the case.

In addition, users 401 associated with Servicing 404 can directly access any of the third-party resources/services and systems 406, 407 via the business system connectors 114 to provide one or more servicing operations.

The Document Management 405 category can include components responsible for managing agreements and other documents and information, including those generated and/or received by the platform 102. Such other documents and information can include, for example, amendments, addendums, notices of control, etc. associated with one or more agreements. The management of such agreements, documents and information can include (without limitation) associating and securely storing agreements and documents, together with their associated metadata (e.g., account data, creation date, document type, party information, etc.), within a document repository 108.

This can include, for example, agreement classification 405a, agreement metadata extraction 405b, communications of metadata extraction 405c and others (not shown). Agreement metadata extraction 405b (or metadata extraction from any other related documents) can involve executing one or more AI-based modeling processes trained to identify and extract such metadata. The extracted metadata can then facilitate database querying, data synchronization with the platform 102 and reportability of existing agreements.

In addition, if a party to a multi-party agreement (e.g., a lender-party) has existing agreements or documents stored in and/or accessible by the platform 102, the platform 102 can execute one or more AI models to extract metadata (and other information) therefrom, and use the metadata/information to build a translated agreement with clauses that would be equivalent or be a better than those in the original agreement. The translated agreement would include clauses that are crafted to reduce risk and streamline the process for approving/executing the multi-party agreement. The extracted metadata and information can also be used to prefill profile templates for parties to a multi-party agreement, as well as provide some or all of the information utilized by the risk wizard engine 107. In this regard, the platform 102 can leverage any metadata and information extracted from existing agreements and documents to assist in servicing agreements throughout their respective life-cycles.

Turning now to FIG. 5, an illustrative dashboard 500 for display via an interactive GUI is shown. In this example, the dashboard 500 is configured to gather user information and guide the user through an agreement-creation journey. To that end, the dashboard 500 includes several predefined areas, including a menu ribbon 501, a journey tracker 502, an input controls area 503, navigation controls 504 and a chatbot 505. Each of these predefined areas can be configured to provide one or combinations of features and functions. Other embodiments of the dashboard 500 can include alternate layouts and/or alternate combinations of features, operations, and designated areas, all in accordance with the present disclosure. In this example, the menu ribbon 501 includes one or more selectable menu buttons such as HOME, PROFILE and HELP, each of which enables a user to access different applications, services and/or functions of the platform 102. For example, selecting the HOME button can automatically return the user to a home screen of the interactive GUI 104a, where the user can view and access other available features and functions of the platform 102. Selecting the PROFILE button can reveal profile data associated with the user. This user profile data can be stored in the platform (e.g., from prior user encounters), viewed and updated by the user as needed. In some embodiments, user profile information can be used to prepopulate one or more portions of a multi-party agreement and/or other associated documents. Selecting the HELP button can avail the user of information to provide the user with customized assistance.

The journey tracker 502 shows the user's progress through an agreement-creation journey. As shown, the user has advanced to the third segment of the agreement-creation journey, which involves collecting additional data and information to define terms of the agreement.

In the input controls area 503, the dashboard 500 can include any combination of text fields, check boxes, radio buttons, dropdown lists, combo boxes, date pickers, dialogue boxes, and the like to gather data and information. In this example, the input controls area 503 is configured to gather data and information for defining terms of the agreement. To that end, each of the input controls gathers a particular type of information.

In some embodiments, such as shown in FIG. 5, input provided via the input controls can trigger the chatbot 505 to automatically generate suggestions and/or informative alerts that is displayed to the user. In this example, the use has selected “No” responsive to the question “Do you want to use the standard state of New York (NY) for its UCC definition?” As a result, the platform 102 automatically generates (e.g., by executing one or more AI models 109a) an alert 505a to inform the user that choosing “Yes” (i.e., selecting NY for its UCC definition) will decrease the risk of this agreement and allow for faster approval. In some embodiments, the chatbot 505 can be configured to generate suggestive actions and/or informative alerts responsive to user input and/or based on events and/or information from sources other than the user (e.g., upon receipt of data from third-party systems/resources 103, upon the occurrence of a predefined event, etc.).

The navigation controls 504 in this example include a “Back” control button 504a and a “Save & Continue” control button 504b. The “Back” control button 504a can be activated to navigate back to a prior stage or page of the agreement journey, while activating the “Save & Continue” will save the user's input and take the user to a next stage or page of the network journey. In some embodiments, failing to complete or provide all required input can prevent the user from navigating forward.

Turning now to FIG. 6A, an illustrative portfolio management dashboard 600 for display via an interactive GUI 104a according to the present disclosure is shown. In this example, the portfolio management dashboard 600 is configured to provide users with an organized and efficient way to view, access and manage their respective agreements. To that end, the dashboard 600 includes several predefined areas, including a menu ribbon 601, an alerts area 602, an agreements area 603, and navigation controls 604. Within the agreements area 603, the dashboard 600 provides filtering features 603a, sorting features 603b, an export feature 603c, and an actionable listing of a user's respective agreements 603d. Each of these predefined areas can be configured to provide one or combinations of features and functions. Other embodiments of the dashboard 600 can include alternate layouts and/or alternate combinations of features, operations, and designated areas, all in accordance with the present disclosure.

In this example, the menu ribbon 601 includes one or more selectable menu buttons such as HOME, PROFILE and HELP, each of which enables a user to access different applications, services and/or functions of the platform 102, as discussed above with respect to FIG. 5 (e.g., sec item 501 in FIG. 5).

The alerts area 602 includes automatically generated suggestions and/or informative alerts pertaining to one or more agreements within the user's portfolio of agreements. In this example, a first alert advises that a document pertaining to one of the user's agreements (e.g., Agreement ID #0123456789) requires an e-signature, and a second alert advises that an account was opened for COMPANY ABC, and that the parties agree to allow Bank X provide updates to a creditor. Also included in each of these alerts are actionable links that, if selected, take the user to documents and/or other features of the platform 102 that enable the user to take further action to resolve the alerts.

As noted above, one of the dashboard's 600 key features includes the ability to organize a user's agreements into a portfolio that the user can view, access, and manage collectively. In this example, the portfolio of agreements is displayed as a list or table 603d. Each agreement within the list 603d is shown represented by an actionable link or icon that, when selected, opens an agreement details window or page. Agreement-level detailed information such as agreement name, party names, agreement status, duration (days) in the status, type of agreement, last activity date, and the like can be displayed alongside each agreement in the list 603d, and the user can customize which data fields are shown to match his/her specific workflow requirements. The user can also interact with the agreement-level data and information, which includes initiating one or more actions directly from within the agreement-level view of the dashboard 650, as shown in FIG. 6B. For example, the user can request agreement terminations, generate amendments, authorize disbursements, or other agreement-related activities, streamlining implementation of these actions and any related document generation, execution, and storage.

Turning now briefly to FIG. 6B, an exemplary agreement-level view 650 of a selected agreement, namely, Agreement ID #0123456789 from the illustrative portfolio management dashboard 600 is shown. Upon selecting the link/icon associated with Agreement ID #0123456789 from the agreements list 603d, the user navigates to the agreement-level view 650 of a selected agreement. This agreement-level view 650 provides the user with a detailed view of all associated documents and data, enabling the user to review or edit agreement data and information directly within the agreement-level view 650. This agreement-level view 650 can be configured to reflect real-time changes in agreement and account level data, ensuring that the user has access to the most current information and can respond promptly to new developments.

As shown, the exemplary agreement-level view 650 maintains the same menu ribbon 601 shown in FIG. 6A. In addition, the exemplary agreement-level view 650 includes an agreement identifier area 651 and an agreement details area 652. The agreement identifier area 651 can include the agreement identification number/name, as well as options for requesting copies of documents or files relating to the selected agreement. The agreement details area 652 can also include options for managing (e.g., initiating actions) related to the selected agreement. As noted above, such actions can include (among others) requesting agreement terminations, generating amendments, authorizing disbursements, or other agreement-related activities. The agreement details area 652 can include additional agreement-specific data and information, such as the names, identities and roles of parties to the agreement, type of agreement, status of the agreement, account numbers associated with the agreement, execution date of agreement, activity/actions taken pertaining to the agreement, contact information of parties to the agreement, and the like. While not shown, this agreement-level view 650 can also include navigation controls to enable the user to return to the portfolio management dashboard 600 view of the user's portfolio.

Returning now to FIG. 6A, agreements area 603 of the dashboard 600 also includes filtering features 603a and sorting features 603b for filtering and/or sorting agreements according to various criteria (e.g., agreement status or type, date created, etc.), thereby enabling the user to customize his/her respective views to focus on specific data points (e.g., agreement type, activity date, deadline, etc.). In this example, the filtering features 603a enable the user to filter by status or type, although other filtering options can be incorporated into this dashboard 600. The sorting features 603b enable the user to sort the agreements list 603d according to any of the displayed fields. In some embodiments, the dashboard 600 can be configured to filter and/or sort agreements across portfolios. In addition, agreement data can be exported via the export feature 603c from the dashboard 600 to spreadsheet formats for offline analysis, and users can download copies of agreement-related documents for archiving or sharing.

The navigation controls 604 in this example include “First,” “Prev,” “1, 2, 3, . . . 15,” “Next” and “Last” control buttons, although other embodiments can have different numbers and types of navigation controls. In this example, the navigation controls 604 can be activated to access a particular portion or page of the agreement list 603d within the user's portfolio. As shown, up to ten (10) agreements within the user's portfolio can be displayed at the same time, and each display constitutes a page within the user's portfolio. As such, selecting the “First” or “Last” control button will take the user to the first page of agreements or last page of agreements, respectively within the user's portfolio. Similarly selecting the “1”, “2” . . . “15” will take the user to the respective first, second . . . fifteenth page of agreements within the user's portfolio. Selecting the “Prev” control button can take the user back to a prior page of agreements within the user's portfolio, whereas selecting the “Next” control button can take the user to the next page of agreements within the user's portfolio.

By way of illustration, the following are descriptions of exemplary embodiments. In some embodiments, a computer-implemented method is provided. The computer-implemented can be utilized to automate workflows, improve operating efficiencies and improve system security in a multi-party document management platform according to this disclosure. The method may include receiving, by one or more processors, data associated with a multi-party agreement; generating one or more user profiles based on the received data; and executing one or more artificial intelligence (AI) models using the one or more user profiles as input. The method may further include generating a risk score associated with the multi-party agreement based on output from the one or more AI models; determining one or more risk mitigation actions based on the risk score and the output from the one or more AI models; and implementing at least one of the one or more risk mitigation actions to modify the multi-party agreement. The method may also include monitoring user interaction with the modified multi-party agreement; updating the one or more AI models based on the monitored user interaction; and automatically adjusting one or more operating parameters of the multi-party document management platform based on the updated AI models. As will be appreciated, this can improve system security or operating efficiency.

In some embodiments, the one or more risk mitigation actions may comprise at least one of: modifying one or more clauses in the multi-party agreement, adjusting access permissions for one or more parties to the multi-party agreement (and/or to one or more associated account(s)), and/or implementing additional authentication requirements for high-risk operations. Automatically adjusting the one or more operating parameters may include modifying document approval workflows, adjusting data encryption levels for stored documents, and/or updating user authentication protocols.

In some embodiments, the method may further include generating a recommendation for improving the risk score and presenting, via an interactive graphical user interface (GUI), the recommendation to at least one party associated with the multi-party agreement. The method may also include receiving, via the user interface, user feedback regarding the recommendation and utilizing the user feedback to further update the one or more AI models. This may involve generating a new training data set that includes a combination of a prior training data set and the feedback, and re-training the one or more AI models according to the new training data set. The feedback may include a combination of accepted and rejected recommendations.

In some embodiments, monitoring user interaction may comprise tracking user actions related to viewing, editing, or approving the modified multi-party agreement, and analyzing patterns in the tracked user actions to identify potential risks and automated actions to initiate responsive to the potential risks. The automated actions may include at least one from among the group consisting of generating alerts or notices, and initiating or modifying one or more workflows related to agreement modification, agreement termination, generation of amendment, agreement notice of control, disbursement requests, or data processing.

In some embodiments, the method may further include generating a portfolio-level risk assessment for a group of multi-party agreements and implementing portfolio-wide risk mitigation actions based on the portfolio-level risk assessment. The data associated with the multi-party agreement may be received from multiple sources, including user input and third-party systems, and the method may further comprise normalizing the received data prior to generating the one or more user profiles.

In some embodiments, the method may include continuously monitoring for changes in external factors affecting the risk score and automatically initiating a re-assessment of the risk score when a change in external factors is detected. Automatically adjusting the one or more operating parameters may comprise identifying inefficiencies in document processing workflows based on the updated AI models and modifying the document processing workflows to reduce processing time or resource utilization.

In some embodiments, a system comprising a multi-party document management platform as described herein is provided. The system may include one or more processors and a memory storing instructions that, when executed by the one or more processors, cause the system to perform operations similar to those described above in connection with the method embodiments. These operations may include receiving data associated with a multi-party agreement, generating user profiles, executing AI models, generating risk scores, determining and implementing risk mitigation actions, monitoring user interactions, updating AI models and/or automatically adjusting operating parameters.

Embodiments of the subject matter and the functional operations described in this disclosure can be implemented in digital electronic circuitry, in tangibly embodied computer software or firmware, in computer hardware, including the structures disclosed in this disclosure and their structural equivalents, or in combinations of one or more of them. Embodiments of the subject matter described in this disclosure may be implemented as one or more computer programs, i.e., one or more modules of computer program instructions encoded on a tangible non-transitory storage medium/program carrier for execution by, or to control the operation of, a data processing apparatus (or a computing system). Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including by way of example a programmable processor, a computer, a server or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, an application program, an engine, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, special purpose microprocessors or another kind of specifically configured central processing unit. A central processing unit according to this disclosure may receive instructions and data from a read-only memory or a random-access memory or both. Elements of a computer may include one or more central processing units for performing or executing instructions and one or more memory devices for storing instructions and data. A computer may also include, or be operatively coupled to receive, data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a laptop computer, a desktop computer, a television, a mobile audio or video player, a game console, a Global Positioning System (GPS), an assisted Global Positioning System (AGPS) receiver, a portable storage device, such as a universal serial bus (USB) flash drive, to name just a few.

Computer-readable media suitable for storing computer program instructions and data may include all forms of non-volatile memory, media and memory devices, including by way of example, semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this disclosure can be implemented on a computer having a display device, such as a CRT (cathode ray tube), LCD (liquid crystal display) monitor or other suitable display device for displaying information to the user and one or more input devices (e.g., a keyboard and a pointing device, such as a mouse or a trackball) by which the user can provide input to the computer. Other kinds of devices can be used to provide for interaction with a user as well such as, for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described herein can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this disclosure, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server may be co-located and/or remote from each other, and they may interact through one or more of a wired and wireless communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this disclosure includes many specifics, these should not be construed as limitations on the scope of the disclosure or of what may be claimed, but rather as descriptions of features specific to particular embodiments of the disclosure. Certain features that are described in this disclosure in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations depicted and/or described with reference to the drawings may include a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments may have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the disclosure as well as meanings understood by those skilled in the art and/or as defined in dictionaries, treatises, etc. It is also noted that, as used in the disclosure and the appended claims, the singular forms “a,” “an,” and “the” include plural referents unless otherwise specified, and that the terms “comprises” and/or “comprising,” when used in this disclosure, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. A computer-implemented method comprising:
receiving, by one or more processors, data associated with a multi-party agreement;
generating, by the one or more processors, one or more user profiles based on the received data;
executing, by the one or more processors, one or more artificial intelligence (AI) models using the one or more user profiles as input;
generating, by the one or more processors, a risk score associated with the multi-party agreement based on output from the one or more AI models;
determining, by the one or more processors, one or more risk mitigation actions based on the risk score and the output from the one or more AI models;
implementing, by the one or more processors, at least one of the one or more risk mitigation actions to modify the multi-party agreement;
monitoring, by the one or more processors, user interaction with the modified multi-party agreement;
updating, by the one or more processors, the one or more AI models based on the monitored user interaction; and
automatically adjusting, by the one or more processors, one or more operating parameters of the multi-party document management platform based on the updated AI models.

2. The method of claim 1, wherein the one or more risk mitigation actions comprise at least one from among the group consisting of:
modifying one or more clauses in the multi-party agreement;
adjusting access permissions for one or more parties to the multi-party agreement or to one or more accounts related to the multi-party agreement; and
implementing additional authentication requirements for high-risk operations.

3. The method of claim 1, wherein automatically adjusting the one or more operating parameters comprises at least one from among the group consisting of:
modifying document approval workflows;
adjusting data encryption levels for stored documents; and
updating user authentication protocols.

4. The method of claim 1, further comprising:
generating, by the one or more processors, a recommendation for improving the risk score; and
presenting, via an interactive graphical user interface (GUI), the recommendation to at least one party associated with the multi-party agreement.

5. The method of claim 4, further comprising:
receiving, via the user interface, user feedback regarding the recommendation; and
utilizing the user feedback to further update the one or more AI models by generating a new training data set that includes a combination of a prior training data set and the feedback, and re-training the one or more AI models according to the new training data set.

6. The method of claim 5, wherein the feedback includes a combination of accepted and rejected recommendations.

7. The method of claim 1, wherein monitoring user interaction comprises:
tracking user actions related to viewing, editing, or approving the modified multi-party agreement; and
analyzing patterns in the tracked user actions to identify potential risks and automated actions to initiate responsive to the potential risks.

8. The method of claim 7, wherein the automated actions include at least one from among the group consisting of:
generating alerts or notices; and
initiating or modifying one or more workflows related to agreement modification, agreement termination, generation of amendment, agreement notice of control, or data processing.

9. The method of claim 1, further comprising:
generating, by the one or more processors, a portfolio-level risk assessment for a group of multi-party agreements; and
implementing portfolio-wide risk mitigation actions based on the portfolio-level risk assessment.

10. The method of claim 1, wherein the data associated with the multi-party agreement is received from multiple sources, including user input and third-party systems, and the method further comprises:
normalizing the received data prior to generating the one or more user profiles.

11. The method of claim 1, further comprising:
continuously monitoring, by the one or more processors, for changes in external factors affecting the risk score; and
automatically initiating a re-assessment of the risk score when a change in external factors is detected.

12. The method of claim 1, wherein automatically adjusting the one or more operating parameters comprises:
identifying inefficiencies in document processing workflows based on the updated AI models; and
modifying the document processing workflows to reduce processing time or resource utilization.

13. A system comprising:
one or more processors; and
a memory storing instructions that, when executed by the one or more processors, cause the system to:
receive data associated with a multi-party agreement;
generate one or more user profiles based on the received data;
execute one or more artificial intelligence (AI) models using the one or more user profiles as input;
generate a risk score associated with the multi-party agreement based on output from the one or more AI models;
determine one or more risk mitigation actions based on the risk score and the output from the one or more AI models;
implement at least one of the one or more risk mitigation actions to modify the multi-party agreement;
monitor user interaction with the modified multi-party agreement;
update the one or more AI models based on the monitored user interaction; and
automatically adjust one or more operating parameters of the multi-party document management platform based on the updated AI models.

14. The system of claim 13, wherein the one or more risk mitigation actions comprise at least one from among the group consisting of:
modifying one or more clauses in the multi-party agreement;
adjusting access permissions for one or more parties to the multi-party agreement or to one or more accounts associated with the multi-party agreement; and
implementing additional authentication requirements for high-risk operations.

15. The system of claim 13, wherein automatically adjusting the one or more operating parameters comprises at least one from among the group consisting of:
modifying document approval workflows;
adjusting data encryption levels for stored documents; and
updating user authentication protocols.

16. The system of claim 13, wherein the instructions further cause the system to:
generate a recommendation for improving the risk score; and
present, via an interactive GUI, the recommendation to at least one party associated with the multi-party agreement.

17. The system of claim 16, wherein the instructions further cause the system to:
receive, via the user interface, user feedback regarding the recommendation; and
utilize the user feedback to further update the one or more AI models by generating a new training data set that includes a combination of a prior training data set and the feedback, and re-training the one or more AI models according to the new training data set.

18. The system of claim 17, wherein the feedback includes a combination of accepted and rejected recommendations.

19. The system of claim 13, wherein monitoring user interaction comprises:
tracking user actions related to viewing, editing, or approving the modified multi-party agreement; and
analyzing patterns in the tracked user actions to identify potential risks and automated actions to initiate responsive to the potential risks.

20. The system of claim 19, wherein the automated actions include at least one from among the group consisting of:
generating alerts or notices; and
initiating or modifying one or more workflows related to agreement modification, agreement termination, generation of amendment, agreement notice of control, or data processing.

21. The system of claim 13, wherein the instructions further cause the system to:
generate a portfolio-level risk assessment for a group of multi-party agreements; and
implement portfolio-wide risk mitigation actions based on the portfolio-level risk assessment.

22. The system of claim 13, wherein the data associated with the multi-party agreement is received from multiple sources, including user input and third-party systems, and wherein the instructions further cause the system to normalize the received data prior to generating the one or more user profiles.

23. The system of claim 13, wherein the instructions further cause the system to:
continuously monitor for changes in external factors affecting the risk score; and
automatically initiate a re-assessment of the risk score when a change in external factors is detected.

24. The system of claim 13, wherein automatically adjusting the one or more operating parameters comprises:
identifying inefficiencies in document processing workflows based on the updated AI models; and
modifying the document processing workflows to reduce processing time or resource utilization.
